(19) United States
(12) Patent Application Publication
(10) Pub. No.: US 2026/0359677 A1
(43) Pub. Date: Nov. 12, 2026

(54) DATA PROCESSING METHODS AND RELATED PRODUCTS

(71) Applicant: Huawei Technologies Co., Ltd., Shenzhen (CN)

(72) Inventors: Weisen Shi, Kanata (CA); Xu Li, Nepean (CA); Hang Zhang, Ottawa (CA); Chenchen Yang, Ottawa (CA)

(21) Appl. No.: 19/648,731

(22) Filed: Apr. 15, 2026

Related U.S. Application Data
(63) Continuation of application No. PCT/CN2023/125174, filed on Oct. 18, 2023.

(51) Int. Cl. G06N 5/04

(52) U.S. Cl. CPC G06N 5/04

(57) ABSTRACT

The present disclosure provides data processing methods and related products. By obtaining a final prediction related to first characteristic information of a third node in an environment and used for updating of a second node, a first node or a fourth node is enabled to provide a reward prediction result, which thus enables the second node to generate an action matching the first characteristic information of the third node. Further, by performing configuration for carrying out a target task initiated by the third node based on a fourth indication indicative of a type of feedback data about a first observation provided by the third node, the feedback data provided by the third node can be leveraged to help configuring a system for executing the target task.

### CROSS-REFERENCE TO RELATED APPLICATION

This application is a continuation of International Patent Application No. PCT/CN2023/125174, filed on Oct. 18, 2023, the disclosure of which is hereby incorporated by reference in its entirety.

### TECHNICAL FIELD

The present disclosure relates to the field of artificial intelligence technologies in data processing, and in particular, to data processing methods and related products.

### BACKGROUND

The massive artificial intelligence (AI) model with millions or billions parameters has shown great potentials in various AI applications (e.g., Large Language Model Meta AI (LLaMA)), and is regarded as the most promising future AI technology. In massive AI model training, the reinforcement learning from human feedback (RLHF) technique has been proved to play an important role for fine-tuning the massive AI model.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, an embodiment of the present disclosure provides a data processing method, including: acquiring, by a first node, a first observation, where the first observation is indicative of a state of an environment in response to an action of a second node; and obtaining, by the first node, a first prediction for the action of the second node based on the first observation, where the first prediction is related to first characteristic information of a third node in the environment, and the first prediction is used for updating of the second node.

By obtaining the first prediction related to the first characteristic information of the third node in the environment and used for updating of the second node, the first node can provide a more accurate reward prediction result, which enables the second node to generate an action matching the first characteristic information of the third node.

In a possible implementation of the first aspect, the first node is associated with multiple pieces of characteristic information, and the first characteristic information is included in the multiple characteristic information.

In this implementation, as the first node is associated with multiple pieces of characteristic information including the first characteristic information, therefore, the pre-trained first node can be used for providing more accurate reward prediction result for customers with different characteristics, e.g., expertise categories.

In a possible implementation of the first aspect, obtaining, by the first node, the first prediction for the action of the second node based on the first observation includes: determining, by the first node, the first prediction based on the first observation and a first indication from the fourth node, where the first indication is indicative of the first characteristic information of the third node and determined by the fourth node based on feedback data about the first observation provided by the third node.

In this implementation, since the first indication is indicative of the first characteristic information and determined by the fourth node based on feedback data about the first observation provided by the third node, the feedback data provided by the third node can be leveraged to help identifying the first characteristic information of the third node.

In a possible implementation of the first aspect, the first node is trained by using a first training dataset, the first training dataset includes multiple pieces of training data, each piece of training data includes a first data portion and a second data portion, the second data portion is indicative of characteristic information of the first data portion.

In this implementation, since the first node is trained by using the training data including the first data portion and the second data portion indicative of the characteristic information of the first data portion, the first node can provide a more accurate reward prediction result based on the first characteristic information indicated by the first indication and the feedback data about the first observation.

In a possible implementation of the first aspect, the first node includes multiple subnodes, each of the multiple subnodes is associated with a piece of characteristic information among the multiple pieces of characteristic information.

In this implementation, the first node includes multiple subnodes, parameters of each of the multiple subnodes can be optimized/trained to be associated with a piece of characteristic information among the multiple pieces of characteristic information, thus each subnode could provide a reward prediction result based on characteristic information, and all together can provide a more accurate reward prediction result.

In a possible implementation of the first aspect, obtaining, by the first node, the first prediction for the action of the second node based on the first observation includes:
for each of the multiple subnodes, determining, by the subnode, a second prediction for the action of the second node based on the first observation, and determining, by the subnode, a weight corresponding to the second prediction based on a second indication from a fourth node, where the second indication is indicative of the first characteristic information of the third node and determined by the fourth node based on feedback data about the first observation provided by the third node;
obtaining, by a first subnode among the multiple subnodes, a weighted sum of the second predictions of the multiple subnodes based on the second prediction of each of the multiple subnodes and the weight corresponding to the second prediction as the first prediction.

In this implementation, each of the multiple subnodes determines a second prediction for the action of the second node based on the first observation, and determines a weight corresponding to the second prediction, so that the first prediction can be determined by the first subnode among the multiple subnodes to be the weighted sum of the second predictions of the multiple subnodes, which enables the first subnode to provide a more accurate reward prediction result.

In a possible implementation of the first aspect, determining, by the subnode, the weight corresponding to the second prediction includes: determining, by the subnode, the weight corresponding to the second prediction based on the second indication and characteristic information associated with the subnode.

In this implementation, the second indication which is indicative of the first characteristic information of the third node is sent to the multiple subnodes for each of the multiple subnodes to determine the weight corresponding to the second prediction, the determined weight can thus be used for calibrating the initial second prediction, which enables the first subnode to provide a more accurate reward prediction result based on the calibrated second prediction.

In a possible implementation of the first aspect, for each of the multiple subnodes, the second indication is further indicative of a weight corresponding to the subnode.

In this implementation, the fourth node determines the second indication indicative of the weight corresponding to each of the multiple subnodes and sends it to the multiple subnodes, so that there is no need for the multiple subnodes to determine the weight corresponding to the second prediction based on the second indication. Instead, the first subnode among the multiple subnodes could determine the weighted sum of the second predictions directly based on the weight indicated by the second indication, which enables the first subnode to provide a more accurate reward prediction result.

In a possible implementation of the first aspect, the method further includes:
for each of the multiple subnodes, determining, by the subnode, a third prediction for the action of the second node based on the first observation, and sending, by the subnode, the third prediction to a fourth node, to enable the fourth node to determine a third indication indicative of the first prediction based on the third prediction and feedback data about the first observation provided by the third node;
where obtaining, by the first node, the first prediction for the action of the second node based on the first observation includes:
receiving, by a first subnode among the multiple subnodes, the third indication indicative of the first prediction sent by the fourth node.

In this implementation, each of the multiple subnodes determines the third prediction and sends the third prediction to the fourth node, so that the fourth node can determine the third indication indicative of the first prediction (which would be a more accurate reward prediction result for the action of the second node) based on the third prediction and the feedback data and send the third indication to the first subnode among the multiple subnodes, which enables the first subnode to provide a more accurate reward prediction result. Further, the calculation is done by the fourth node, thereby reducing the processing pressure on the first node, besides, the first prediction can be sent from the first subnode to the second node, so the fourth node does not need to directly interact with the second node, the operation of the fourth node is thus simplified.

In a possible implementation of the first aspect, the first subnode is predefined or selected by the fourth node.

In this implementation, the first subnode, which acts as an anchor node and undertakes more interaction tasks than other subnodes, can be predefined or selected by the fourth node, which can simplify the operation of the data processing method.

In a possible implementation of the first aspect, the first prediction includes third predictions respectively determined by the multiple subnodes;
where obtaining, by the first node, the first prediction for the action of the second node based on the first observation includes:
for each of the multiple subnodes, determining, by the subnode, a third prediction for the action of the second node based on the first observation;
where the method further includes:
for each of the multiple subnodes, sending, by each of the multiple subnodes, the third prediction to the fourth node, to enable the fourth node to determine a fourth prediction for the action of the second node based on the third prediction and feedback data about the first observation provided by the third node, where the fourth prediction corresponds to the first characteristic information of the third node in the environment.

In this implementation, each of the multiple subnodes determines the third prediction and sends the third prediction to the fourth node, so that the fourth node can determine the fourth prediction (which would be a more accurate reward prediction result for the action of the second node) corresponding to the first characteristic information of the third node in the environment based on the third prediction and the feedback data about the first observation provided by the third node, which enables the fourth node to provide a more accurate reward prediction result. Further, the calculation is done by the fourth node, thereby reducing the processing pressure on the first node, besides, the first prediction can be sent directly from the fourth node to the second node, thus reducing the signaling cost.

In a possible implementation of the first aspect, the first node is trained by using a second training dataset, the second training dataset includes multiple groups of training data, and each group of training data corresponds to predefined characteristic information among the multiple pieces of characteristic information.

In this implementation, because the first node is trained by using the training data corresponding to the predefined characteristic information among the multiple pieces of characteristic information, the reward prediction result provided by the first node would be more accurate.

In a possible implementation of the first aspect, the method further includes:
sending, by the first node, the first prediction to the second node, to enable the updating of the second node.

In this implementation, the first prediction sent by the first node to the second node is used for the updating of the second node, so that the parameters/model(s) of the second node updated according to the first prediction are more accurate.

In a possible implementation of the first aspect, acquiring, by the first node, the first observation includes:
receiving, by the first node, the first observation from the third node; or,
receiving, by the first node, the first observation broadcasted by a fourth node.

In this implementation, the first node receives the first observation from the third node or receives the first observation broadcasted by the fourth node, the reception manner of the first observation by the first node is diversified.

In a second aspect, an embodiment of the present disclosure provides a data processing method, including:
receiving, by a fourth node, feedback data about a first observation from a third node, where the first observation is indicative of a state of an environment in response to an action of a second node.

By receiving the feedback data about the first observation from the third node, the fourth node can determine the first characteristic information of the third node based on the feedback data, thereby making it possible to get a reward prediction result matching the first characteristic information of the third node.

In a possible implementation of the second aspect, the first node includes multiple subnodes, each of the multiple subnodes is associated with a piece of characteristic information among the multiple pieces of characteristic information;

where the method further includes:
receiving, by the fourth node, a third prediction from each of the multiple subnodes;
determining, by the fourth node, a final prediction for the action of the second node based on the third prediction and the feedback data about the first observation from the third node, where the final prediction corresponds to first characteristic information of the third node in the environment.

In this implementation, the first node includes multiple subnodes, the parameters of each of the multiple subnodes can be optimized/trained to be associated with a piece of characteristic information among the multiple pieces of characteristic information, which can provide a more accurate reward prediction result. In addition, each of the multiple subnodes determines the third prediction and sends the third prediction to the fourth node, the fourth node determines the final prediction for the action of the second node based on the third prediction and the feedback data about the first observation from the third node, which is conducive to provide a more accurate reward prediction result.

In a possible implementation of the second aspect, determining, by the fourth node, the final prediction includes:
determining, by the fourth node, a similarity between the feedback data and the third prediction from each of the multiple subnodes; and
determining, by the fourth node, the final prediction based on the third prediction and the similarity between the feedback data and the third prediction from each of the multiple subnodes.

In this implementation, the final prediction is determined based on the third prediction and the similarity between the feedback data and the third prediction from each of the multiple subnodes, which is conducive to provide a more accurate reward prediction result.

In a possible implementation of the second aspect, determining, by the fourth node, the final prediction based on the third prediction and the similarity between the feedback data and the third prediction from each of the multiple subnodes includes:
in a case that there is at least one third prediction whose similarity is greater than or equal to a preset threshold, determining, by the fourth node, a third prediction with a highest similarity as the final prediction;
in a case that there is no third prediction whose similarity is greater than or equal to the preset threshold, determining, by the fourth node, a weight corresponding to the third prediction of each of the multiple subnodes based on the similarity between the feedback data and the third prediction and calculating, by the fourth node, a weighted sum of the third predictions of the multiple subnodes based on the third prediction of each of the multiple subnodes and the weight corresponding to the third prediction as the final prediction.

In this implementation, the final prediction can be determined based on the third prediction in diversified ways, thus a more accurate reward prediction result is provided.

In a possible implementation of the second aspect, the final prediction is a first prediction;

the method further includes:
selecting, by the fourth node, a first subnode from the multiple subnodes based on the similarities of the third predictions of the multiple subnodes; and
sending, by the fourth node, a third indication indicative of the first prediction to the first subnode.

In this implementation, the first subnode is selected from the multiple subnodes based on the similarities of the third predictions of the multiple subnodes, and the first subnode is notified of its role (as an anchor subnode) by virtue of the third indication indicative of the first prediction in a more flexible way.

In a possible implementation of the second aspect, the final prediction is a fourth prediction;

the method further includes:
sending, by the fourth node, the fourth prediction to the second node.

In this implementation, the final prediction is sent by the fourth node directly to the second node, which avoids forwarding of the final prediction and reduces the signaling required for implementing the data processing method.

In a possible implementation of the second aspect, the method further includes:
determining, by the fourth node, first characteristic information of the third node based on the feedback data.

In this implementation, the first characteristic information of the third node is determined based on the feedback data about the first observation from the third node, the feedback data provided by the third node can be leveraged to help identifying the first characteristic information of the third node.

In a possible implementation of the second aspect, the method further includes:
sending, by the fourth node, a first indication to the first node, where the first indication is indicative of the first characteristic information of the third node.

In this implementation, since the first indication is indicative of the first characteristic information of the third node and is sent by the fourth node to the first node, the reward prediction result subsequently determined by the first node based on the first indication is more accurate. That is, the first indication can be leveraged to help providing a more accurate reward prediction result.

In a possible implementation of the second aspect, the first node includes multiple subnodes, each of the multiple subnodes is associated with a piece of characteristic information among the multiple pieces of characteristic information;

where the method further includes:
sending, by the fourth node, a second indication to each of the multiple subnodes, where the second indication is indicative of the first characteristic information of the third node; or,

for each of the multiple subnodes, determining, by the fourth node, a weight corresponding to characteristic information associated with the subnode, and sending, by the fourth node, a second indication to the subnode, where the second indication is indicative of the first characteristic information of the third node and the weight corresponding to the subnode.

In this implementation, the first node includes multiple subnodes, the parameters of each of the multiple subnodes can be optimized/trained to be associated with a piece of characteristic information among the multiple pieces of characteristic information, which can provide a more accurate reward prediction result. In addition, the fourth node sends the second indication indicative of the first characteristic information of the third node or further indicative of the weight corresponding to the subnode to each of the multiple subnodes, so that the final prediction can be determined by a first subnode among the multiple subnodes according to the second indication, which enables the first subnode to provide a more accurate reward prediction result.

In a possible implementation of the second aspect, the first node includes multiple subnodes, each of the multiple subnodes is associated with a piece of characteristic information among the multiple pieces of characteristic information;

where the method further includes:
receiving, by the fourth node, a third prediction from each of the multiple subnodes;

for each of the multiple subnodes, determining, by the fourth node, a weight corresponding to the third prediction of the subnode based on the first characteristic information of the third node and characteristic information associated with the subnode;

calculating, by the fourth node, a weighted sum of the third predictions of the multiple subnodes based on the third prediction of each of the multiple subnodes and the weight corresponding to the third prediction as the final prediction as a fourth prediction; and sending, by the fourth node, the fourth prediction to the second node.

In this implementation, the first node includes multiple subnodes, the parameters of each of the multiple subnodes can be optimized/trained to be associated with a piece of characteristic information among the multiple pieces of characteristic information, which can provide a more accurate reward prediction result. In addition, the fourth node receives the third prediction from each of the multiple subnodes, and determines, for each of the multiple subnodes, the weight corresponding to the third prediction of the subnode based on the first characteristic information of the third node and the characteristic information associated with the subnode, and calculates the weighted sum of the third predictions of the multiple subnodes as the fourth prediction sent to the second node, which can provide a more accurate reward prediction result.

In a possible implementation of the second aspect, determining, by the fourth node, the first characteristic information of the third node based on the feedback data includes:
determining, by the fourth node, the first characteristic information of the third node based on the feedback data and a preset classification algorithm.

In this implementation, the first characteristic information of the third node is determined based on the feedback data about the first observation from the third node and the preset classification algorithm, the feedback data provided by the third node can be leveraged to help identifying the first characteristic information of the third node.

In a possible implementation of the second aspect, the method further includes:
receiving, by the fourth node, the first observation from the third node; and
broadcasting, by the fourth node, the first observation to each of the multiple subnodes.

In this implementation, the first observation is received by the fourth node from the third node and broadcasted to each of the multiple subnodes of the first node, which reduces the processing pressure of the third node since the third node would no longer need to send the first observation to each of the subnodes, and enables the first node to determine a more accurate reward prediction result according to the first observation.

In a third aspect, an embodiment of the present disclosure provides a data processing method, including:
sending, by a third node, feedback data about a first observation to a fourth node, to enable the fourth node to determine first characteristic information of the third node or a final prediction for an action of a second node performed on an environment, where the first observation is indicative of a state of the environment in response to the action of the second node, where the final prediction corresponds to the first characteristic information, and the final prediction is a first prediction determined by a first node or a fourth prediction determined by the fourth node.

By receiving the feedback data about the first observation from the third node, the fourth node can determine the first characteristic information of the third node based on the feedback data, thereby making it possible to get a reward prediction result matching the first characteristic information of the third node.

In a possible implementation of the third aspect, the method further includes:
sending, by the third node, the first observation to the first node or the fourth node.

In a fourth aspect, an embodiment of the present disclosure provides a data processing method, including:
receiving, by a second node, a final prediction for an action of the second node performed on an environment, where the final prediction corresponds to first characteristic information of a third node in the environment, where the final prediction is based on a first observation and feedback data about the first observation, the first observation is indicative of a state of the environment in response to the action of the second node, and the final prediction is a first prediction determined by a first node or a fourth prediction determined by a fourth node; and
performing, by the second node, updating based on the final prediction.

By receiving the final prediction for the action of the second node performed on the environment and performing updating based on the final prediction, the second node is enabled to generate an action matching the first characteristic information.

In a fifth aspect, an embodiment of the present disclosure provides a data processing method, including:
sending, by a fifth node, a first request to a sixth node, where the first request includes first information and second information, the first information is indicative of characteristic information for training of a first node, and the second information is indicative of a data attribute associated with the characteristic information;
receiving, by the fifth node, a first response from the sixth node, where the first response is determined by the sixth node based on the first request and is indicative of a capability of the sixth node for supporting the training of the first node; and
performing, by the fifth node based on the first response, configuration on the first node and the sixth node for conducting the training.

By virtue of the interaction between the fifth node and the sixth node, the fifth node can perform configuration based on the capability of the sixth node, thus making the first node and the sixth node prepared for the training and further enabling the trained first node to determine a more accurate reward prediction result.

In a possible implementation of the fifth aspect, performing, by the fifth node based on the first response, the configuration on the first node and the sixth node for conducting the training includes:
determining, by the fifth node, first configuration information and second configuration information of the first node based on the first response, where the first configuration information is indicative of a type of the first node, and the second configuration information is indicative of parameters for the training of the first node;
configuring, by the fifth node, the first node based on the first configuration information and the second configuration information; and
notifying, by the fifth node, the sixth node of configuration of the first node.

In this implementation, the type of the first node and parameters for the training of the first node are used by the fifth node to configure the first node, thus enabling the trained first node to determine a more accurate reward prediction result.

In a possible implementation of the fifth aspect, determining, by the fifth node, the first configuration information of the first node includes:
determining, by the fifth node, a type of the first node based on the first response, where the type of the first node includes a first type and a second type, where a node of the first type includes one integrated node associated with multiple pieces of characteristic information, a node of the second type includes multiple subnodes, and each of the multiple subnodes is associated with a piece of characteristic information among the multiple pieces of characteristic information;
where notifying, by the fifth node, the sixth node of configuration of the first node includes:
notifying, by the fifth node, the sixth node of the type of the first node.

In this implementation, the type of the first node is determined based on the first response and notified the sixth node, which is conducive to configure the first node, and is thus conducive to improve the accuracy of the first node in determining a reward prediction result.

In a possible implementation of the fifth aspect, the first response includes an indication of characteristic information supported by the sixth node, and an indication of the sixth node having required data for the training of the first node;

where determining, by the fifth node, the first configuration information of the first node further includes:
determining, by the fifth node, a number of candidate nodes for implementing the first node based on the indication of the characteristic information supported by the sixth node;
where determining, by the fifth node, the second configuration information of the first node includes:
   determining, by the fifth node, the second configuration information based on the indication of the sixth node having required data for the training of the first node.

In this implementation, the indication of the characteristic information supported by the sixth node and the indication of the sixth node having required data for the training of the first node are used by the fifth node to configure the first node, therefore, the configured first node would be well-matched with the sixth node, and further enabling the trained first node to determine a more accurate reward prediction result.

In a possible implementation of the fifth aspect, the second configuration information includes a first type of parameters and a second type of parameters, where the first type of parameters remains unchanged during the training of the first node and the second type of parameters is subject to updating based on training data provided by the sixth node during the training of the first node.

In this implementation, the parameters for configuring the first node are divided into different types, i.e., parameters remaining unchanged during the training of the first node and parameters subject to updating during the training of the first node, therefore, the configuration can be implemented in a more accurate way.

In a possible implementation of the fifth aspect, the first type of parameters includes at least one of a structure of a neural network for the training of the first node, and an approach for the training of the first node;

where the second type of parameters includes at least one of initial weights and bias for the neural network.

In a possible implementation of the fifth aspect, configuring, by the fifth node, the first node based on the first configuration information and the second configuration information include:
configuring, by the fifth node, a network element for implementing the first node and a connection between the sixth node and the first node based on the first configuration information and the second configuration information.

In this implementation, the first configuration information and the second configuration information are used to configure the network element for implementing the first node and a connection between the sixth node and the first node, which is conducive to configure the first node, and is thus conducive to improve the accuracy of the first node in determining a reward prediction result.

In a possible implementation of the fifth aspect, notifying, by the fifth node, the sixth node of the configuration of the first node includes:
sending, by the fifth node, third information to the sixth node, where the third information is indicative of at least one path between the first node and the sixth node.

In this implementation, information indicative of at least one path between the first node and the sixth node is sent by the fifth node to the sixth node, which is conducive to transmission of training data to the first node for the training of the first node, and is thus conducive to improve the accuracy of the first node in determining a reward prediction result.

In a possible implementation of the fifth aspect, the method further includes:
sending, by the fifth node, fourth information to the sixth node, where the fourth information is indicative of a training dataset for the first node.

In this implementation, information indicative of the training dataset for the first node is sent by the fifth node to the sixth node, which is conducive to determine training data to be provided to the first node for the training of the first node, and is thus conducive to improve the accuracy of the first node in determining a reward prediction result.

In a possible implementation of the fifth aspect, the fourth information is further indicative of a format of data for the training of the first node.

In this implementation, the format of data for the training of the first node is sent by the fifth node to the sixth node, which is conducive to transmission of training data to the first node for the training of the first node, and is thus conducive to improve the accuracy of the first node in determining a reward prediction result.

In a possible implementation of the fifth aspect, the first information includes at least one indication of at least one piece of characteristic information respectively, and the second information includes a minimum volume of data associated with each of the at least one piece of characteristic information.

In this implementation, at least one indication of at least one piece of characteristic information respectively and a minimum volume of data associated with each of the at least one piece of characteristic information are sent by the fifth node to the sixth node, which is leveraged to help training of the first node, and is thus conducive to improve the accuracy of the first node in determining a reward prediction result.

In a sixth aspect, an embodiment of the present disclosure provides a data processing method, including:
receiving, by a sixth node, a first request from a fifth node, where the first request includes first information and second information, the first information is indicative of characteristic information for training of a first node, and the second information is indicative of a data attribute associated with the characteristic information;
determining, by the sixth node, a first response based on the first request, where the first response is indicative of a capability of the sixth node for supporting the training of the first node; and
sending, by the sixth node, the first response to the fifth node.

By virtue of the interaction between the fifth node and the sixth node, the sixth node can show its capability to the fifth node, and the fifth node can perform configuration based on the capability of the sixth node, thus making the first node and the sixth node prepared for the training and further enabling the trained first node to determine a more accurate reward prediction result.

In a possible implementation of the sixth aspect, the first response includes an indication of characteristic information supported by the sixth node, and an indication of the sixth node having required data for the training of the first node;

where determining, by the sixth node, the first response based on the first request includes:
determining, by the sixth node, the indication of characteristic information supported by the sixth node based on the first information, and
determining, by the sixth node, the indication of the sixth node having required data for the training of the first node based on the second information.

In this implementation, the first response includes the indication of characteristic information supported by the sixth node and the indication of the sixth node having required data for the training of the first node, which are respectively determined based on the first information and the second information, which is conducive to configure the first node, and is thus conducive to improve the accuracy of the first node in determining a reward prediction result.

In a possible implementation of the sixth aspect, the method further includes:
receiving, by the sixth node, third information from the fifth node, where the third information is indicative of at least one path between the first node and the sixth node.

In this implementation, information indicative of at least one path between the first node and the sixth node is sent by the fifth node to the sixth node, which is conducive to transmission of training data to the first node for the training of the first node, and is thus conducive to improve the accuracy of the first node in determining a reward prediction result.

In a possible implementation of the sixth aspect, the method further includes:
receiving, by the sixth node, a training request from the first node, where the training request is indicative of characteristic information of the first node;
determining, by the sixth node, training data for the first node based on a type of the first node and the training request; and
sending, by the sixth node, the training data to the first node based on the third information, to enable the first node to conduct the training based on the training data.

In this implementation, the training data for the first node corresponding to the characteristic information of the first node is determined by the sixth node based on the type of the first node and the training request received from the first node, and sent to the first node based on the third information, which is conducive to training of the first node, and is thus conducive to improve the accuracy of the first node in determining a reward prediction result.

In a possible implementation of the sixth aspect, the method further includes:
receiving, by the sixth node, fourth information from the fifth node, where the fourth information is indicative of a training dataset for the first node.

In this implementation, information indicative of the training dataset for the first node is sent by the fifth node to the sixth node, which is conducive to transmission of training data to the first node for the training of the first node, and is thus conducive to improve the accuracy of the first node in determining a reward prediction result.

In a possible implementation of the sixth aspect, the method further includes:
upon determining that the first node is of a first type which includes one integrated node associated with multiple pieces of characteristic information, determining, by the sixth node, a first training dataset based on the fourth information and sending, by the sixth node, training data of the first training dataset to the first node based on the third information, to enable the first node to conduct the training based on the training data of the first training dataset;
upon determining that the first node is of a second type which includes multiple subnodes with each of the multiple subnodes being associated with a piece of characteristic information among the multiple pieces of characteristic information, determining, by the sixth node, a second training dataset based on the fourth information and sending, by the sixth node, training data of the second training dataset to each of the multiple subnodes based on the third information, to enable the first node to conduct the training based on the training data of the second training dataset;
where the first training dataset includes multiple pieces of training data, each piece of training data includes a first data portion and a second data portion, the second data portion is indicative of characteristic information of the first data portion; the second training dataset includes multiple groups of training data, and each group of training data is associated with predefined characteristic information among the multiple pieces of characteristic information.

In this implementation, the training dataset is determined by the sixth node based on the type of the first node and the third information, and sent to the first node based on the fourth information, to enable the first node to conduct the training based on training data of the training dataset, which is conducive to improve the accuracy of the first node in determining a reward prediction result.

In a possible implementation of the sixth aspect, the type of the first node is predefined or notified by the sixth node.

In this implementation, the type of the first node is predefined or notified by the sixth node, which simplifies the signaling used in determination of the training dataset, and thus simplifies the process of the training of the first node.

In a seventh aspect, an embodiment of the present disclosure provides a data processing method, including:
receiving, by the first node, training data from a sixth node, where the training data corresponds to characteristic information of the first node; and
conducting, by the first node, training based on the training data from the sixth node.

In this implementation, the training data for the first node corresponding to the characteristic information of the first node is received from the first node and used to conduct the training, which is conducive to improve the accuracy of the first node in determining a reward prediction result.

In a possible implementation of the seventh aspect, the method further includes:
sending, by the first node, a training request to the sixth node, where the training request is indicative of the characteristic information of the first node.

In this implementation, the training request, which is subsequently used for determining the training data for the first node used to conduct the training, is sent by the first node to the sixth node, which is leveraged to help improving the accuracy of the first node in determining a reward prediction result.

In a possible implementation of the seventh aspect, the first node is of a first type which includes one integrated node associated with multiple pieces of characteristic information;

where receiving, by the first node, training data from the sixth node includes:
receiving, by the first node, training data of a first training dataset from the sixth node, where the first training dataset includes multiple pieces of training data, each piece of training data includes a first data portion and a second data portion, the second data portion is indicative of characteristic information of the first data portion.

In this implementation, because the first node is trained by using the training data including the first data portion and the second data portion indicative of the characteristic information of the first data portion, the reward prediction result provided by the first node is more accurate.

In a possible implementation of the seventh aspect, the first node is of a second type which includes multiple subnodes with each of the multiple subnodes being associated with a piece of characteristic information among the multiple pieces of characteristic information;

where receiving, by the first node, training data from the sixth node includes:
receiving, by the first node, training data of a second training dataset from the sixth node, where the second training dataset includes multiple groups of training data, and each group of training data is associated with predefined characteristic information among the multiple pieces of characteristic information.

In this implementation, because the first node is trained by using the training data dataset including multiple groups of training data, each of which is associated with predefined characteristic information among the multiple pieces of characteristic information, the reward prediction result provided by the first node is more accurate.

In an eighth aspect, an embodiment of the present disclosure provides a data processing method, including:
acquiring, by a fifth node, a fourth indication from a third node, where the fourth indication is indicative of a type of feedback data about a first observation provided by the third node; and
performing, by the fifth node based on the fourth indication, configuration for carrying out a target task initiated by the third node.

Because the configuration for carrying out the target task initiated by the third node is performed based on the fourth indication indicative of the type of feedback data about the first observation provided by the third node, the feedback data provided by the third node can be leveraged to help configuring a system for executing the target task.

In a possible implementation of the eighth aspect, acquiring, by the fifth node, the fourth indication from the third node includes:
sending, by the fifth node, a second request to the third node, where the second request is used for requesting the type of the feedback data; and
receiving, by the fifth node, the fourth indication from the third node.

In this implementation, the fifth node sends, to the third node, the second request used for requesting the type of the feedback data to acquire the type of feedback data about the first observation provided by the third node for performing the configuration for carrying out the target task initiated by the third node, the system for executing the target task can be well configured.

In a possible implementation of the eighth aspect, the second request is used for requesting at least one of items: a format of the feedback data, a frequency at which the third node provides the feedback data or an interface required by the third node;

where the fourth indication is further indicative of at least one of the items requested by the fifth node.

In this implementation, the fifth node sends, to the third node, the second request used for requesting at least one of items: the format of the feedback data, the frequency at which the third node provides the feedback data or the interface required by the third node, so as to perform the configuration for carrying out the target task initiated by the third node based on these items in a more flexible way, the system for executing the target task can be well configured.

In a possible implementation of the eighth aspect, the method further includes:
receiving, by the fifth node, a third request from a third node, where the third request is indicative of description information corresponding to the target task.

In this implementation, the third request indicative of the description information corresponding to the target task is sent from the third node to the fifth node, which is conducive to carry out the target task.

In a possible implementation of the eighth aspect, performing, by the fifth node based on the fourth indication, the configuration for carrying out the target task initiated by the third node includes:
determining, by the fifth node based on the description information corresponding to the target task, a first node and a second node for carrying out the target task;
determining, by the fifth node based on the type of the feedback data and the first node, operations performed by the first node, the second node and a fourth node for carrying out the target task, where the fourth node is used for providing a prediction of an observation provided by the third node;
configuring, by the fifth node, network elements and connections for implementing the operations performed by the first node, the second node and the fourth node based on the operations performed by the first node, the second node and the fourth node; and
notifying, by the fifth node based on the network elements and connections for implementing the operations performed by the first node, the second node and the fourth node, the third node of the configuration for carrying out the target task.

In this implementation, by determining the first node and the second node for carrying out the target task, determining the operations performed by the first node, the second node and the fourth node, configuring, by the fifth node, the network elements and the connections for implementing the operations performed by the first node, the second node and the fourth node, and notifying the third node of the configuration for carrying out the target task, the system for executing the target task can be well configured.

In a possible implementation of the eighth aspect, determining, by the fifth node based on the description information corresponding to the target task, the first node for carrying out the target task includes:
determining, by the fifth node based on the description information corresponding to the target task, at least one candidate node which has carried out a historical task as the first node, where a similarity between the historical task and the target task is above a preset threshold.

Since the first node is determined to be the at least one candidate node which has carried out the historical task having a similarity with the target task that is above a preset threshold, the reuse of such first node makes the configuration much easier.

In a possible implementation of the eighth aspect, determining, by the fifth node based on the description information corresponding to the target task, the first node for carrying out the target task includes:
determining, by the fifth node based on the description information corresponding to the target task, a type of the first node, where the type of the first node includes a first type and a second type, where a node of the first type includes one integrated node associated with multiple pieces of characteristic information, a node of the second type includes multiple subnodes, and each of the multiple subnodes is associated with a piece of characteristic information among the multiple pieces of characteristic information;
upon determining that the first node is of the second type, determining, by the fifth node, all available candidate nodes as the subnodes of the first node.

In this implementation, by determining the type of the first node based on the description information corresponding to the target task, the system for executing the target task can be well configured.

In a possible implementation of the eighth aspect, notifying, by the fifth node based on the network elements and connections for implementing the operations performed by the first node, the second node and the fourth node, the third node of the configuration for carrying out the target task includes:
sending, by the fifth node, a third configuration notification to the third node, where the third configuration notification is indicative of the network element for implementing the operations performed by the first node and a connection between the third node and the first node; or,
sending, by the fifth node, a third configuration notification to the third node, where the third configuration notification is indicative of the network element for implementing the operations performed by the fourth node and a connection between the third node and the fourth node.

In this implementation, the third configuration notification indicative of the network element for implementing the operations performed by the first node or the fourth node and the connection between the third node and the first node or the fourth node is sent by the fifth node to the third node, the third node of the system for executing the target task can be well configured.

In a possible implementation of the eighth aspect, the method further includes:
sending, by the fifth node, a first configuration notification to the first node, where the first configuration notification is indicative of the operations performed by the first node;
sending, by the fifth node, a second configuration notification to the second node, where the second configuration notification is indicative of the operations performed by the second node; and
sending, by the fifth node, a fourth configuration notification to the fourth node, where the fourth configuration notification is indicative of the operations performed by the fourth node.

In this implementation, different configuration notification is respectively sent by the fifth node to the first node, the second node and the fourth node of the system for executing the target task, so as to well configure the first node, the second node and the fourth node, and make them perform the operations accordingly.

In a possible implementation of the eighth aspect, the type of the feedback data includes a first feedback type and a second feedback type, where the first feedback type of the feedback data is indicative of an evaluation of the third node on an observation, and the second feedback type of the feedback data is indicative of characteristic information of the third node.

In this implementation, the feedback data has two different types, so that the operations performed by the nodes of the system for executing the target task can be determined based on the type of the feedback data, so as to well configure the nodes of the system for executing the target task.

In a ninth aspect, an embodiment of the present disclosure provides a data processing method, including:
receiving, by a first node, a first configuration notification from a fifth node, where the first configuration notification is indicative of operations performed by the first node for carrying out a target task initiated by a third node, where the operations are determined by the fifth node based on description information corresponding to the target task and a type of feedback data provided by the third node; and
performing, by the first node, configuration based on the first configuration notification.

The configuration of the first node is performed based on the first configuration notification indicative of the operations performed by the first node for carrying out the target task initiated by the third node, where the operations are determined by the fifth node based on the description information corresponding to the target task and the type of feedback data provided by the third node, the feedback data provided by the third node can be leveraged to help configuring a system for executing the target task.

In a tenth aspect, an embodiment of the present disclosure provides a data processing method, including:
receiving, by a second node, a second configuration notification from a fifth node, where the second configuration notification is indicative of operations performed by the second node for carrying out a target task initiated by a third node, where the operations are determined by the fifth node based on description information corresponding to the target task and a type of feedback data provided by the third node; and
performing, by the second node, configuration based on the second configuration notification.

The configuration of the second node is performed based on the first configuration notification indicative of the operations performed by the second node for carrying out the target task initiated by the third node, where the operations are determined by the fifth node based on the description information corresponding to the target task and the type of feedback data provided by the third node, the feedback data provided by the third node can be leveraged to help configuring a system for executing the target task.

In an eleventh aspect, an embodiment of the present disclosure provides a data processing method, including:
sending, by a third node, a fourth indication to a fifth node, to enable the fifth node to perform configuration for carrying out a target task initiated by the third node based on the fourth indication, where the fourth indication is indicative of a type of feedback data provided by the third node.

Because the configuration for carrying out the target task initiated by the third node is performed based on the fourth indication indicative of the type of feedback data about the first observation provided by the third node, the feedback data provided by the third node can be leveraged to help configuring a system for executing the target task.

In a possible implementation of the eleventh aspect, the method further includes:
receiving, by the third node, a second request from the fifth node, where the second request is used for requesting the type of the feedback data.

In this implementation, the third node receives, from the fifth node, the second request used for requesting the type of the feedback data to acquire the type of feedback data about the first observation provided by the third node for performing the configuration for carrying out the target task initiated by the third node, the system for executing the target task can be well configured.

In a possible implementation of the eleventh aspect, the second request is used for requesting at least one of items: a format of the feedback data, a frequency at which the third node provides the feedback data or an interface required by the third node;

where the fourth indication is further indicative of at least one of the items requested by the fifth node.

In this implementation, the third node receives, from the fifth node, the second request used for requesting at least one of items: the format of the feedback data, the frequency at which the third node provides the feedback data or the interface required by the third node, so as to perform the configuration for carrying out the target task initiated by the third node based on these items, the system for executing the target task can be well configured.

In a possible implementation of the eleventh aspect, the method further includes:
sending, by the third node, a third request to the fifth node, where the third request is indicative of description information corresponding to the target task.

In this implementation, the third request indicative of the description information corresponding to the target task is sent from the third node to the fifth node, which is conducive to carry out the target task.

In a possible implementation of the eleventh aspect, the method further includes:
receiving, by a third node, a third configuration notification from the fifth node, where the third configuration notification is indicative of a network element for implementing operations performed by a first node and a connection between the third node and the first node; or, the third configuration notification is indicative of a network element for implementing operations performed by a fourth node and a connection between the third node and the fourth node; and
performing, by the third node, configuration based on the third configuration notification.

In this implementation, the third configuration notification indicative of the network element for implementing the operations performed by the first node or the fourth node and the connection between the third node and the first node or the fourth node is sent by the fifth node to the third node, the third node of the system for executing the target task can be well configured.

In a twelfth aspect, an embodiment of the present disclosure provides a data processing method, including:
receiving, by a fourth node, a fourth configuration notification from a fifth node, where the fourth configuration notification is indicative of operations performed by the fourth node for carrying out a target task initiated by a third node, where the operations are determined by the fifth node based on description information corresponding to the target task and a type of feedback data provided by the third node; and
performing, by the fourth node, configuration based on the fourth configuration notification.

The configuration of the fourth node is performed based on the first configuration notification indicative of the operations performed by the fourth node for carrying out the target task initiated by the third node, where the operations are determined by the fifth node based on the description information corresponding to the target task and the type of feedback data provided by the third node, the feedback data provided by the third node can be leveraged to help configuring a system for executing the target task.

In a thirteenth aspect, an embodiment of the present disclosure provides a data processing method, including:
acquiring, by a first node, a first observation, where the first observation is indicative of a state of an environment in response to an action of a second node;
sending, by the third node, feedback data about the first observation to the fourth node;
obtaining, by the first node, a first prediction for the action of the second node based on the first observation, where the first prediction is related to first characteristic information of a third node in the environment, the first prediction is a final prediction or a third prediction used for a fourth node to generate a fourth prediction as the final prediction, where the final prediction corresponds to the first characteristic information, and the final prediction is based on the first observation and the feedback data;
receiving, by the fourth node, the feedback data from the third node;
receiving, by the second node, the final prediction for the action of the second node performed on the environment from the first node or the fourth node; and
performing, by the second node, updating based on the final prediction.

By obtaining the final prediction related to the first characteristic information of the third node in the environment and used for updating of the second node, the first node or the fourth node is enabled to provide a reward prediction result, which thus enables the second node to generate an action matching the first characteristic information of the third node.

In a fourteenth aspect, an embodiment of the present disclosure provides a data processing method, including:
sending, by a fifth node, a first request to a sixth node, where the first request includes first information and second information, the first information is indicative of characteristic information for training of a first node, and the second information is indicative of a data attribute associated with the characteristic information;
receiving, by the sixth node, the first request from the fifth node;
determining, by the sixth node, a first response based on the first request, where the first response is indicative of a capability of the sixth node for supporting the training of the first node;
sending, by the sixth node, the first response to the fifth node;
receiving, by the fifth node, the first response from the sixth node;
performing, by the fifth node based on the first response, configuration on the first node and the sixth node for conducting the training;
sending, by the sixth node, training data to the first node, where the training data corresponds to characteristic information of the first node;
receiving, by the first node, training data from the sixth node; and
conducting, by the first node, the training based on the training data from the sixth node.

By conducting training of the first node based on the training data corresponding to the characteristic information of the first node after performing configuration on the first node and the sixth node based on the first response indicative of a capability of the sixth node for supporting the training of the first node, the accuracy of the first node in determining a reward prediction result is improved.

In a fifteenth aspect, an embodiment of the present disclosure provides a data processing method, including:
sending, by a third node, a fourth indication to a fifth node, where the fourth indication is indicative of a type of feedback data about a first observation provided by the third node;
acquiring, by the fifth node, the fourth indication from the third node;
performing, by the fifth node, configuration for carrying out a target task initiated by the third node based on the fourth indication.

By performing configuration for carrying out the target task initiated by the third node based on the fourth indication indicative of the type of the feedback data about the first observation provided by the third node, the feedback data provided by the third node can be leveraged to help configuring a system for executing the target task.

In a sixteenth aspect, an embodiment of the present disclosure provides a data processing system, including:
a first node, configured to execute the data processing method according to the first aspect or any possible implementation of the first aspect;
a second node, configured to execute the data processing method according to the fourth aspect;
a third node, configured to execute the data processing method according to the third aspect or the possible implementation of the third aspect; and
a fourth node, configured to execute the data processing method according to the second aspect or any possible implementation of the second aspect.

In a seventeenth aspect, an embodiment of the present disclosure provides a data processing system, including:
a first node, configured to execute the data processing method according to the seventh aspect or any possible implementation of the seventh aspect;
a fifth node, configured to execute the data processing method according to the fifth aspect or any possible implementation of the fifth aspect; and
a sixth node, configured to execute the data processing method according to the sixth aspect or any possible implementation of the sixth aspect.

In an eighteenth aspect, an embodiment of the present disclosure provides a data processing system, including:
a first node, configured to execute the data processing method according to the ninth aspect;
a second node, configured to execute the data processing method according to the tenth aspect;
a third node, configured to execute the data processing method according to the eleventh aspect or any possible implementation of the eleventh aspect;
a fourth node, configured to execute the data processing method according to the twelfth aspect; and
a fifth node, configured to execute the data processing method according to the eighth aspect or any possible implementation of the eighth aspect.

In a nineteenth aspect, an embodiment of the present disclosure provides a data processing apparatus, the data processing apparatus includes various modules configured to execute the data processing method according to the first aspect or any possible implementation of the first aspect, or according to the seventh aspect or any possible implementation of the seventh aspect, or according to the ninth aspect.

In a twentieth aspect, an embodiment of the present disclosure provides a data processing apparatus, the data processing apparatus includes various modules configured to execute the data processing method according to the fourth aspect or according to the tenth aspect.

In a twenty-first aspect, an embodiment of the present disclosure provides a data processing apparatus, the data processing apparatus includes various modules configured to execute the data processing method according to the third aspect or any possible implementation of the third aspect, or according to the eleventh aspect or any possible implementation of the eleventh aspect.

In a twenty-second aspect, an embodiment of the present disclosure provides a data processing apparatus, the data processing apparatus includes various modules configured to execute the data processing method according to the second aspect or any possible implementation of the second aspect, or according to the twelfth aspect.

In a twenty-third aspect, an embodiment of the present disclosure provides a data processing apparatus, the data processing apparatus includes various modules configured to execute the data processing method according to the fifth aspect or any possible implementation of the fifth aspect, or according to the eighth aspect or any possible implementation of the eighth aspect.

In a twenty-fourth aspect, an embodiment of the present disclosure provides a data processing apparatus, the data processing apparatus includes various modules configured to execute the data processing method according to the sixth aspect or any possible implementation of the sixth aspect.

In a twenty-fifth aspect, an embodiment of the present disclosure provides a first node including processing circuitry for executing the data processing method according to according to the first aspect or any possible implementation of the first aspect, or according to the seventh aspect or any possible implementation of the seventh aspect and the ninth aspect.

In a twenty-sixth aspect, an embodiment of the present disclosure provides a second node including processing circuitry for executing the data processing method according to the fourth aspect or according to the tenth aspect.

In a twenty-seventh aspect, an embodiment of the present disclosure provides a third node including processing circuitry for executing the data processing method according to the third aspect or any possible implementation of the third aspect, or according to the eleventh aspect or any possible implementation of the eleventh aspect.

In a twenty-eighth aspect, an embodiment of the present disclosure provides a fourth node including processing circuitry for executing the data processing method according to the second aspect or any possible implementation of the second aspect, or according to the twelfth aspect.

In a twenty-ninth aspect, an embodiment of the present disclosure provides a fifth node including processing circuitry for executing the data processing method according to the fifth aspect or any possible implementation of the fifth aspect, or according to the eighth aspect or any possible implementation of the eighth aspect.

In a thirtieth aspect, an embodiment of the present disclosure provides a sixth node including processing circuitry for executing the data processing method according to the sixth aspect or any possible implementation of the sixth aspect.

In a thirty-first aspect, an embodiment of the present disclosure provides a computer-readable medium storing computer execution instructions which, when executed by a processor, causes the processor to execute the data processing method according to any one of the first aspect or any possible implementation of the first aspect to the fifteenth aspect.

In a thirty-second aspect, an embodiment of the present disclosure provides a computer program product including computer execution instructions which, when executed by a processor, causes the processor to execute the data processing method according to any one of the first aspect or any possible implementation of the first aspect to the fifteenth aspect.

The present disclosure provides data processing methods and related products. By obtaining a final prediction related to first characteristic information of a third node in an environment and used for updating of a second node, a first node or a fourth node is enabled to provide a reward prediction result, which thus enables the second node to generate an action matching the first characteristic information of the third node. In addition, by conducting training of the first node based on the training data corresponding to characteristic information of the first node after performing configuration on the first node and a sixth node based on a first response indicative of a capability of the sixth node for supporting the training of the first node, the accuracy of the first node in determining a reward prediction result is improved. Further, by performing configuration for carrying out a target task initiated by the third node based on a fourth indication indicative of a type of feedback data about a first observation provided by the third node, the feedback data provided by the third node can be leveraged to help configuring a system for executing the target task.

### BRIEF DESCRIPTION OF DRAWINGS

Reference will now be made, by way of example, to the accompanying drawings which show example embodiments of the present disclosure, and in which:

FIG. 1 is a simplified schematic illustration of a communication system according to one or more embodiments of the present disclosure.

FIG. 2 is a schematic illustration of an example communication system according to one or more embodiments of the present disclosure.

FIG. 3 is a schematic illustration of a basic component structure of a communication system according to one or more embodiments of the present disclosure.

FIG. 4 illustrates a block diagram of a device in a communication system according to one or more embodiments of the present disclosure.

FIG. 5 is a schematic framework of a traditional RLHF system.

FIG. 6 is a schematic framework of an RLCF system provided by the present disclosure.

FIG. 7A is a schematic framework of an RLCF system alpha with multiple ERPs according to one or more embodiments of the present disclosure.

FIG. 7B is a schematic framework of an RLCF system beta with only one integrated ERP (I-ERP) according to one or more embodiments of the present disclosure.

FIG. 8 is a workflow of an RLCF system provided by the present disclosure.

FIG. 9A is a flowchart of a first data processing method according to one or more embodiments of the present disclosure.

FIG. 9B is a possible implementation corresponding to the process shown in FIG. 9A.

FIG. 10A is a flowchart of a second data processing method according to one or more embodiments of the present disclosure.

FIG. 10B is a possible implementation corresponding to the process shown in FIG. 10A.

FIG. 11 is a flowchart of a third data processing method according to one or more embodiments of the present disclosure.

FIG. 12A is a schematic view of a fourth data processing method according to one or more embodiments of the present disclosure.

FIG. 12B is a possible implementation corresponding to the process shown in FIG. 12A.

FIG. 13A is a schematic view of a fifth data processing method according to one or more embodiments of the present disclosure.

FIG. 13B is a possible implementation corresponding to the process shown in FIG. 13A.

FIG. 14A is a schematic view of a sixth data processing method according to one or more embodiments of the present disclosure.

FIG. 14B is a possible implementation corresponding to the process shown in FIG. 14A.

FIG. 15A is a schematic view of a seventh data processing method according to one or more embodiments of the present disclosure.

FIG. 15B is a possible implementation corresponding to the process shown in FIG. 15A.

FIG. 16 is a schematic view of a data processing apparatus according to one or more embodiments of the present disclosure.

FIG. 17 is a schematic view of another data processing apparatus according to one or more embodiments of the present disclosure.

FIG. 18 is a schematic view of a further another data processing apparatus according to one or more embodiments of the present disclosure.

FIG. 19 is a schematic view of still another data processing apparatus according to one or more embodiments of the present disclosure.

FIG. 20 is a schematic view of yet another data processing apparatus according to one or more embodiments of the present disclosure.

FIG. 21 is a schematic view of yet another data processing apparatus according to one or more embodiments of the present disclosure.

FIG. 22 is a schematic view of yet another data processing apparatus according to one or more embodiments of the present disclosure.

FIG. 23 is a schematic view of yet another data processing apparatus according to one or more embodiments of the present disclosure.

FIG. 24 is a schematic view of yet another data processing apparatus according to one or more embodiments of the present disclosure.

FIG. 25 is a schematic view of yet another data processing apparatus according to one or more embodiments of the present disclosure.

FIG. 26 is a schematic view of yet another data processing apparatus according to one or more embodiments of the present disclosure.

FIG. 27 is a schematic view of yet another data processing apparatus according to one or more embodiments of the present disclosure.

### DESCRIPTION OF EMBODIMENTS

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example communication systems and devices

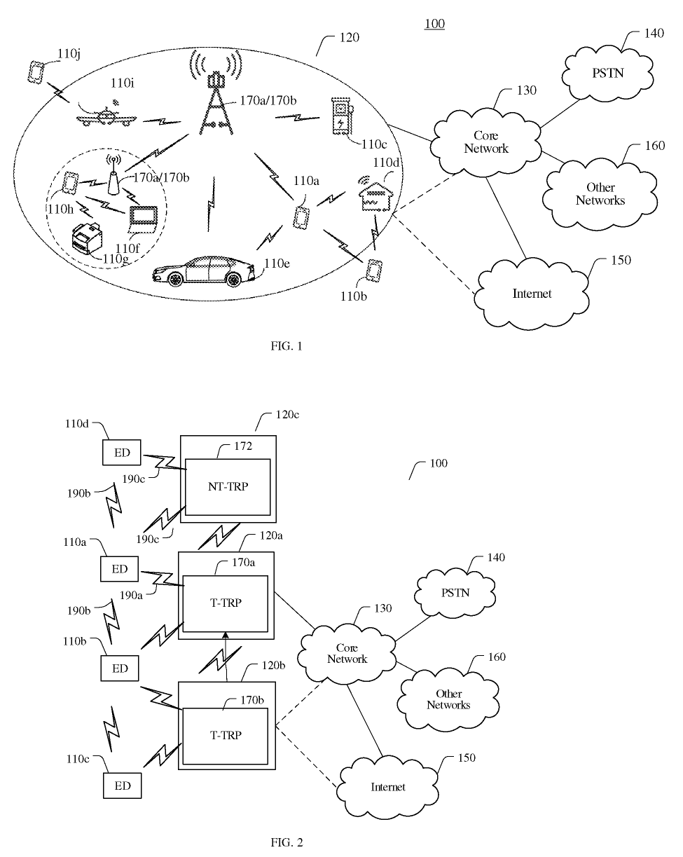

Referring to FIG. 1, as an illustrative example without limitation, a simplified schematic illustration of a communication system is provided. The communication system 100 includes a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

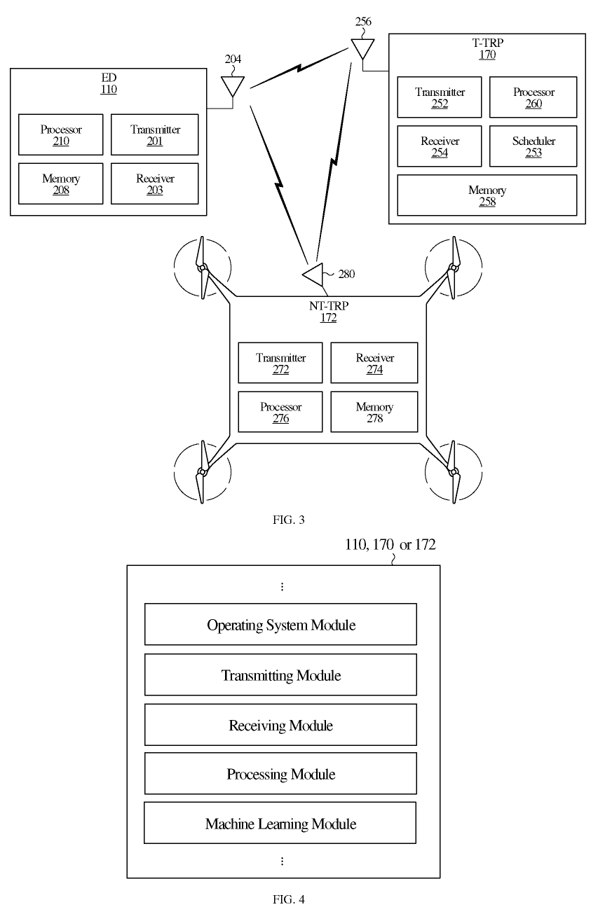

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non- terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190cwith NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. In some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120aand 120band/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

### Basic component structure

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. communication module, modem, or chip) in the foregoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

### Basic module structure

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### 6G intelligent air interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6GHz and beyond 6GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Terminal types

The data processing method provided in the embodiment of the present disclosure may be applied to various communication scenarios, for example, may be applied to one or more of the following communication scenarios: enhanced mobile broadband (enhanced mobile broadband, eMBB), ultra-reliable low-latency communication (ultra-reliable low latency communication, URLLC), and machine type communication (machine type communication, MTC), Internet of Things (IoT), narrowband Internet of Things (narrow band internet of thing, NB-IoT), customer front-end equipment (customer front-end equipment, CPE), augmented reality (augmented reality, AR), virtual reality (virtual reality, VR), mass machine type communications (mMTC), device to device (D2D), vehicle to everything (V2X), vehicle to vehicle (V2V), etc.

It should be noted that in the embodiment of the present disclosure, IoT (internet of thing, IoT) may include one or more of NB-IoT, MTC, mMTC, and the like. This is not limited.

The eMBB may be a large-traffic mobile broadband service such as a three-dimensional (three-dimensional, 3D) or ultra-high-definition video. Specifically, the eMBB may further improve performance such as a network speed and user experience based on a mobile broadband service. For example, when a user watches a 4K HD video, the peak network speed can reach 10 Gbit/s.

URLLC may refer to a service with high reliability, low latency, and extremely high availability. Specifically, the URLLC may include the following communications scenarios and applications: industrial application and control, traffic safety and control, remote manufacturing, remote training, remote surgery, unmanned driving, industrial automation, a security industry, and the like.

MTC may refer to a low-cost and coverage-enhanced service, and may also be referred to as M2M. mMTC refers to large-scale IoT services.

NB-IoT may be a service that features wide coverage, a large number of connections, a low rate, a low cost, low power consumption, and an excellent architecture. Specifically, the NB-IoT may include a smart water meter, smart parking, intelligent pet tracking, a smart bicycle, an intelligent smoke detector, an intelligent toilet, an intelligent vending machine, and the like.

The CPE may refer to a mobile signal access device that receives a mobile signal and forwards the mobile signal by using a wireless fidelity (wireless fidelity, WiFi) signal, or may refer to a device that converts a high-speed 4G or 5G signal into a WiFi signal, and may simultaneously support a relatively large quantity of mobile terminals that access the Internet. CPEs can be widely used for wireless network access in rural areas, towns, hospitals, units, factories, and residential areas, reducing the cost of laying wired networks.

The V2X can enable communication between vehicles, between vehicles and network devices, and between network devices, to obtain a series of traffic information such as a real-time road condition, road information, and pedestrian information, and provide in-vehicle entertainment information to improve driving safety, reduce congestion, and improve traffic efficiency.

For example, the terminal type includes an eMBB device, a URLLC device, an NB-IoT device, and a CPE device. The eMBB device is mainly configured to transmit large-packet data, or may be configured to transmit small-packet data, and is generally in a moving state. Requirements for a transmission delay and reliability are general, and both uplink and downlink communication exists. A channel environment is relatively complex and changeable, and indoor communication or outdoor communication may be used. For example, an eMBB device may be a mobile phone. The URLLC device is mainly configured to transmit small packet data, or may transmit medium packet data. Generally, the URLLC device belongs to a non-moving state, or may move along a fixed route. The URLLC device has a relatively high requirement for a transmission delay and reliability, that is, a low transmission delay and high reliability are required, and both uplink and downlink communications have. The channel environment is stable. For example, the URLLC device may be a factory device. The NB-IoT device is mainly used to transmit small data. The NB-IoT device is generally in a non-moving state, has a known location, has a medium transmission delay and reliability requirement, has a relatively large amount of uplink communication, and has a relatively stable channel environment. For example, the NB-IoT device may be a smart water meter or a sensor. The CPE device is mainly used to transmit large-packet data, is generally in a non-mobile state, or can move over ultra-short distances, has medium requirements on transmission delay and reliability, has both uplink and downlink communication, and has a relatively stable channel environment. For example, The CPE device may be a terminal device, an AR, a VR, or the like in the smart home. When the terminal type of the terminal device is determined, the terminal type may be determined based on a service type, mobility, a transmission delay requirement, a reliability requirement, a channel environment, and a communication scenario of the terminal device. Determining that the terminal type corresponding to the terminal device is an eMBB device, a URLLC device, an NB-IoT device, or a CPE device.

The massive artificial intelligence (AI) model with millions or billions parameters has shown great potentials in various AI applications (e.g., Large Language Model Meta AI (LLaMA)), and is regarded as the most promising future AI technology. In massive AI model training, the reinforcement learning from human feedback (RLHF) technique has been proved to play an important role for fine-tuning the massive AI model. However, the traditional RLHF systems in related art may have some drawbacks which will be described in detail with reference to FIG. 5.

FIG. 5 is a schematic framework of a traditional RLHF system. As shown in FIG. 5, the system includes a reward predictor, an RL algorithm and an environment. Here the RL algorithm may be implemented in an AI model. Generally, the AI model interacts with the environment to produce a set of actions/outputs. During RL training of the RL algorithm, the RL algorithm of the AI model obtains an observation from the environment, and as a response, the RL algorithm produces and outputs an action to the environment. Then, upon being subject to the action from the RL algorithm, the environment generates a responsive observation and sends the responsive observation to the reward predictor, where the responsive observation may include information of a new state of the environment changed as a result of the action of the RL algorithm. The reward predictor then generates a predicted reward according to the responsive observation and sends the predicted reward to the RL algorithm for the RL algorithm to update the parameter(s) thereof according to the predicted reward. The parameters of the RL algorithm are updated by a traditional RL approach (e.g., Q-learning), so that the predicted reward generated by the reward predictor is maximized.

Here the reward predictor may be trained based on human feedback data, that is, the parameter(s) of the reward predictor may be optimized/trained via supervised learning to fit the human feedback data. The reward predictor may be trained off-line before conducting the above process of RL training. The human feedback data may be prepared by selecting (historical) outputs of the RL algorithm, multiple pairs of outputs are randomly generated and sent to a human for comparison to determine which action is appropriate. The comparison results from the human may serve to form a human feedback dataset.

However, in the traditional RLHF system, the reward predictor is trained by general human feedback data which is collected from various people with different preferences or characteristics. Since the general human feedback data can only represent the common/general preferences or behaviors of human, e.g., recognizing objectives in a figure, provide reasonable answers to a question without violating common sense, the traditional RLHF cannot customize the RL algorithm output according to the specific requirements/characteristic/expertise/preference (e.g., expertise in short) of the customer of the RLHF (also referred to as RL customer), which cause the RL algorithm output to be inaccuracy. The RL customer may be defined as a device/application which is manned/used by a person. The expertise of an RL customer is referred to as the expertise of the person who manipulates/uses the customer. For examples, RL customers with financial/business expertise and customers with physics research expertise can have different requirements to the RL algorithm outputs, although they may query the same question, e.g., questions like what are major achievements in Thomas Edison’s life? List major obstacles to fully utilize fusion power?

In addition, in the traditional RLHF system, since the RLHF system pays no attention to distinguish the human feedback data in terms of their sources (from people with different expertise), so there is consequently no mechanism to obtain the pre-knowledge of the customer’s expertise. Besides, in some scenarios, it may be hard or prohibited to collect the customer’s expertise information due to specific reasons, e.g., protecting privacy of the customer.

Further, the RL training and the execution of the whole system in related art is normally in the same network, so there is no system and method to support RLHF as a network-native service.

The objective of the present disclosure is to resolve the preceding issues by a reinforcement learning from customer feedback (RLCF) system with several functional nodes which can be distributed on different network elements and data processing methods related to these functional nodes, in which customer feedback data, which can be collected from a group of other customers with the same expertise as the customer, or the customer itself, can be leveraged to help identifying the expertise of the customer and training the reward predictor, so that the reward predictor can provide a customized reward prediction result, which enables the RL algorithm to generate outputs matching the expertise of the customer. In addition, in the proposed data processing methods and related products of the present disclosure, new network functions and corresponding signaling/procedures are designed to support RLCF as a network-native service.

To achieve the above objective, the present disclosure proposes an RLCF system which can both interact with the environment to conduct the traditional RLHF procedure, and customize the final predicted reward according to the customer feedback data, which in turn enables the customized RL algorithm outputs. The environment considered in the RLCF system may be identical to the environment concept defined in the traditional RLHF system whose state may change according to different RL algorithm outputs. As the reaction to each RL algorithm output, the environment can provide an observation to the RLCF system. The observation may include information of the new state of the environment changed as a result of the action of the RL algorithm, and (in some embodiments) RL algorithm output information, such as an action of the RL algorithm or a triplet consisting of a previous state of the environment, the action of the RL algorithm, the new state of the environment. The RL customer can receive/collect the observations from the environment to determine the customer feedback data to the RLCF system. In some embodiments, the RL customer may be a portion (or the whole) of the environment. In some embodiments, the RL customer may also not be a portion of the environment. In the case where the RL customer is not a portion (or the whole) of the environment, the RL customer may obtain the observation from the RL algorithm.

Before elaborating the systems and related processes proposed by the present disclosure, several functional nodes that would be involved (including a first node, a second node, a third node, a fourth node, a fifth node and a sixth node) will be introduced in the first place.

Throughout the description, the first node may refer to an expert reward predictor, the second node may refer to an RL algorithm, the third node may refer to an RL customer, the fourth node may refer to an expertise classifier (EC), the fifth node may refer to an RLCF controller and the sixth node may refer to a controller of a human feedback dataset (here the controller may refer to any network element that is in charge of the human feedback dataset, so that other entities could extract data, or interact with the human feedback dataset). The names of these functional nodes can be used interchangeably with the elements they refer to.

It should be noted that some or all of these functional nodes can be integrated into one network element or distributed on different network elements, when the arrangement of these functional nodes changes, the interactions among these functional nodes would change correspondingly, detailed description will be made with reference to the method flowcharts later. In the case of integration, these functional nodes may function as different functional modules in one network element.

Specifically, the algorithm implemented by the RL algorithm in the RLCF system may be the same as or different from the RL algorithm in traditional RLHF system. However, the specific operations, especially those interactions with other functional nodes, would be different from those in related art.

There would be one or multiple ERP(s) in the RLHF system, the ERP can generate predicted rewards for the RL algorithm. The parameters of the ERP(s) can be optimized/trained (e.g., via supervised learning) to fit human feedback data with expertise information. Therefore, the ERP(s) in the RLCF system can provide a customized reward prediction result corresponding to the expertise of the RL customer, which enables more accurate reward prediction than the general reward predictor used in traditional RLHF system. The ERP(s) may be trained off-line before executing/training the RL algorithm in the RLCF system.

The human feedback dataset serves to provide training data for the RL training of the RL algorithm, it may include a plurality of human feedback data samples. Each data sample in the human feedback dataset may be associated with pre-determined expertise which corresponds to the expertise of the customer who provides the data sample. For example, a data sample provided by a customer who is a physician/computer engineer is associated with the physician/computer engineer expertise category. For each data sample in the human feedback dataset, its associated expertise category information is defined as the expertise information of a data sample. It should be noted that the human feedback dataset may also include data samples which are not associated with a pre-determined expertise. Since the human feedback dataset is used for the RL training, so the data samples therein may take different forms depending on the specific RLHF system, especially depending on the type of the ERP(s) involved in the RLHF system.

The EC can classify the RL customer into one of multiple pre-determined expertise categories (e.g., physician, computer engineer) according to the customer feedback data. The expertise category classified to the RL customer is identified as the expertise of the RL customer. The EC can send the information of the RL customer’s expertise to the ERP(s) for the ERP(s) to generate customized reward prediction result(s). The EC can be realized as AI/ML based algorithm(s) such as a clustering algorithm. In some embodiments, the EC should interact with the ERP(s) to determine the expertise of the customer. In some embodiments, the EC can receive the predicted reward generated by the ERP(s), then, generate and send the final predicted reward to the RL algorithm.

The RLCF controller is a logic controller which configures the nodes in the RLCF system for executing each RLCF task. An RLCF task is referred to as the procedure to train the RL algorithm in the RLCF system. The execution of an RLCF task can be requested by the RL customer. For example, an RL customer asks a question, which would be regarded as initiating an RLCF task, and then after the execution of the RLCF system, an answer is given to the RL customer, such a process may be the execution of the RLCF task. Actions (e.g., AI inference, AI training, and data processing) are performed by the RLCF system in order to complete the RLCF task. During execution of the RLCF task, the RLCF controller may configure other network functions in the RLCF system. The configuration to the network functions could instruct and enable the network functions to execute corresponding actions to complete the RLCF task.

The RL customer can receive an observation from the environment, generate the customer feedback data according to the observation and send the customer feedback data to the EC.

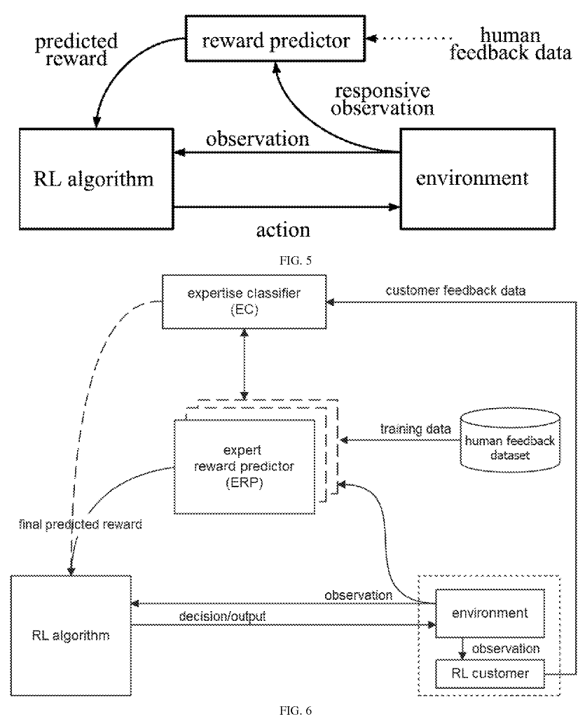

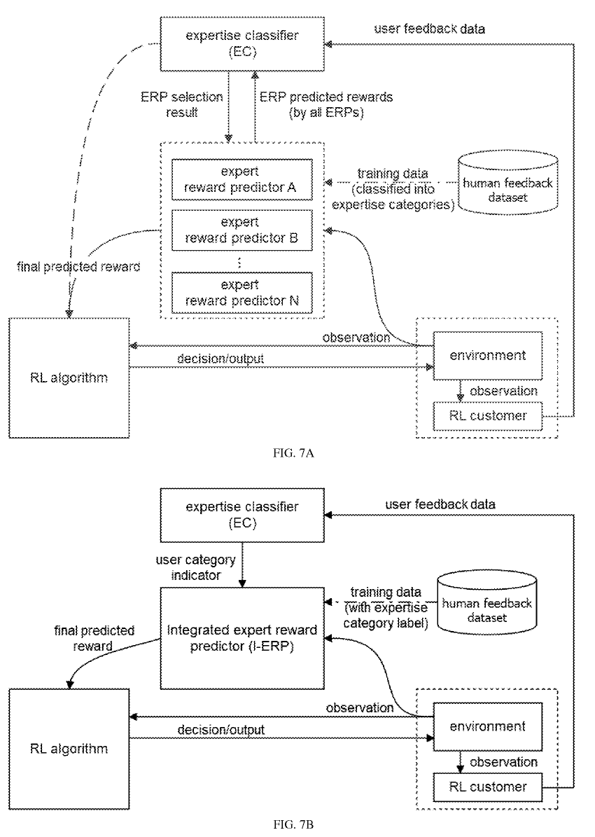

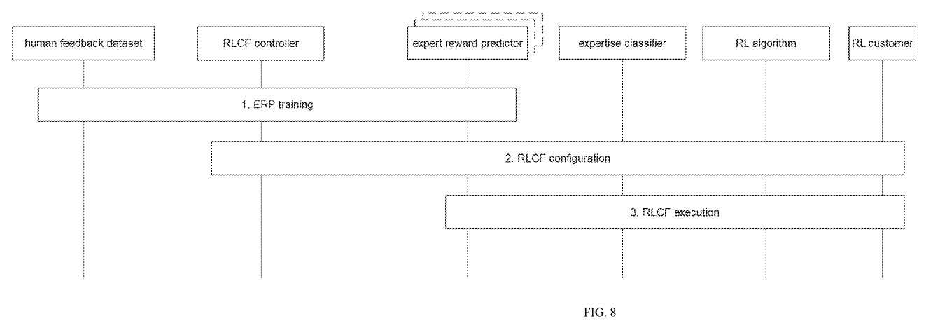

In the following, the basic concept of the present disclosure will be described with reference to FIGS. 6-8. Among them, FIG. 6 is a general RLCF system while FIGS. 7 and 8 are specific implementations of the general RLCF system.

As shown in FIG. 6, the RLCF system includes functional nodes such as one or multiple ERPs, an RL algorithm, an RL customer, an EC, an RLCF controller, there is also a human feedback dataset shown in the figure, this could be implemented as a database.

Generally, the RL algorithm can obtain an observation from the environment, and as a response, the RL algorithm produces and outputs an action (illustrated in FIG. 6 as decision/output) to the environment. Then, upon being subject to the action from the RL algorithm, the environment provides the observation to the RL customer, and the RL customer generates customer feedback data according to the observation and sends the customer feedback data to the EC. The EC then would interact with the ERP to generate a final predicted reward for the RL algorithm, such reward may be sent to the RL algorithm by the EC or the ERP, and then the parameters of the RL algorithm may be updated.

From the perspective of the ERP, there would be two kinds of RLCF systems, as different implementations of the system shown in FIG. 6. One is referred to as an RLCF system alpha (shown in FIG. 7A), in which there are multiple ERPs which are trained with data samples not associated with pre-determined expertise, the other is referred to as an RLCF system beta (shown in FIG. 7B), in which there is an integrated ERP which is trained with data samples associated with pre-determined expertise. Both of the two systems may be used for completing an RLCF task, but functional nodes involved in the RLCF system may perform different operations, which will be described later with reference to the method flowcharts.

As shown in FIG. 7A, the RLCF system alpha includes multiple ERPs, the parameters of each ERP can be optimized/trained (e.g., via supervised learning) to fit a subset (or called a group) of the human feedback dataset. The samples in the human feedback data in the subset can all be classified into a specific expertise (e.g., physician, computer engineer) which is identified as the associated expertise of the ERP. The ERP whose associated expertise is as same as the RL customer’s expertise is defined as the corresponding ERP, which can provide most accurate reward prediction than other ERPs with different associated expertise. That is, the human feedback dataset may include multiple groups of training data (training samples), and each group of training data corresponds to a predefined expertise, different groups of training data correspond to different predefined expertise. Here the different subsets of the human feedback dataset may be stored separately on different network elements or may also be stored in the same network element, which is not limited in the present disclosure.

In the RLCF system alpha, the EC can be configured to determine customer expertise according to 1) simply the customer feedback data; or 2) the customer feedback data and predicted rewards from the multiple ERPs. In some embodiments, the EC can be configured to generate the final predicted reward according to the customer feedback data and the predicted rewards from multiple ERPs, and then send the final predicted reward to the RL algorithm.

As shown in FIG. 7B, the RLCF system beta includes an integrated ERP (referred to as I-ERP), the parameters of the I-ERP can be optimized/trained (e.g., via supervised learning) to fit the general human feedback dataset. Different from both the traditional RLHF system and the RLCF system alpha, each training data used to train the I-ERP is attached by an additional segment indicating its associated expertise, i.e., additional expertise segment. Therefore, the input data of the I-ERP is composed by both an observation segment and an additional expertise segment. While the input data of the ERPs in the RLCF system alpha simply have the observation segment. With the help of additional expertise segment, the I-ERP can adapt the predicted reward according to different customer expertise even given the same observation.

In the RLCF system beta, the EC can be configured to generate data composed by both the observation segment and the additional expertise segment according to the customer feedback data and send the data to the I-ERP as the input data of the I-ERP.

With the above functional nodes, the ERP is first trained based on human feedback data provided by the human feedback dataset, then the RLCF controller may configure the functional nodes involved in the execution of an RLCF task, and then the functional nodes function according to their respective configurations.

As shown in FIG. 8, a workflow of the proposed RLCF system includes three steps of ERP training, RLCF configuration and RLCF execution. Among them:
a) ERP training: the RLCF controller trains one or multiple ERPs (i.e., optimizes/trains the parameters of each ERP by a pre-determined method, e.g., supervised learning) to fit training data provided by the human feedback dataset, where the trained ERP(s) in this step can be reused by different RLCF tasks;
b) RLCF configuration: given a request from the RL customer, the RLCF controller configures the trained ERP(s), EC, and RL algorithm for executing the RLCF task requested by the RL customer;
c) RLCF execution: the RLCF system and RL customer execute the RLCF task according to the execution logic configured by RLCF controller. In the present disclosure, data processing methods are provided to execute the three steps of workflow of the proposed RLCF system, and the corresponding data processing systems are also provided.

In the following, the data processing methods and related products provided by the present disclosure will be described in detail with reference to the accompanying drawings.

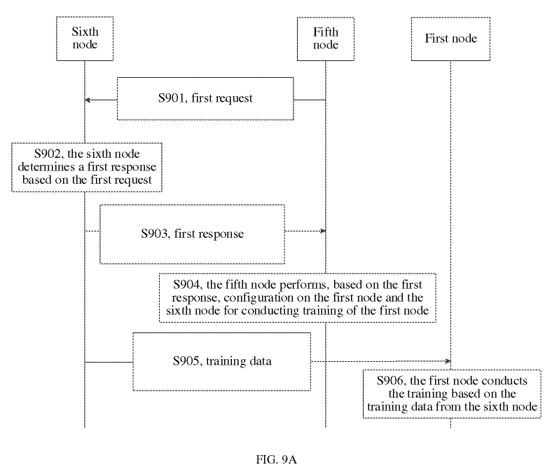

FIG. 9A is a flowchart of a first data processing method according to one or more embodiments of the present disclosure. FIG. 9B is also a possible implementation corresponding to the process shown in FIG. 9A, except that the subject bodies are denoted as human feedback dataset (which means a controller of the human feedback dataset), RLCF controller and ERP, and the information exchanged between different entities are also described with different names. However, the principles shown in both figures are similar. The method can be implemented by the ERP(s) (the first node), the RLCF controller (the fifth node) and the controller of the human feedback dataset (the sixth node) of the RLCF system. As shown in FIG. 9A, the method can include the following steps.

S901, the fifth node sends a first request to a sixth node and the sixth node receives the first request from the fifth node, where the first request includes first information and second information, the first information is indicative of characteristic information for training of a first node, and the second information is indicative of a data attribute associated with the characteristic information.

Specifically, the fifth node may sends a first request to the sixth node for initiating the training of the first node. In a possible implementation of the present disclosure, the first request may be a human feedback training data request as illustrated in FIG. 9B.

In a possible implementation of the present disclosure, the first information includes at least one indication of at least one piece of characteristic information respectively. The characteristic information is used for characterizing the feature of the first node and may be an expertise category required by the RLCF controller to train the ERP, and accordingly, the at least one indication of at least one piece of characteristic information respectively may be identify/identifies (ID(s))/name(s) of the expertise category/categories required by the fifth node to train the first node, or description of the required expertise category/categories if the fifth node has no pre-knowledge of the ID(s)/name(s) of potential expertise category/categories. In a case that the fifth node knows the ID(s))/name(s) of the expertise category/categories required by the fifth node to train the first node, such ID(s))/name(s) would be used as the indication of the characteristic information and may be carried in the first request, while in a case that the fifth node does not know such ID(s))/name(s) but still need to train the first node, then description of the required expertise category/categories may be used as the indication of the characteristic information and may be carried in the first request. In the following, the expertise category will be taken as an example of the characteristic information for description, however, it should be understood that the solution also applies when the characteristic information is other kinds of information.

In this implementation, at least one indication of at least one piece of characteristic information respectively and a minimum volume of data associated with each of the at least one piece of characteristic information are sent by the fifth node to the sixth node, which is leveraged to help training of the first node, and is thus conducive to improve the accuracy of the first node in determining a reward prediction result.

In a possible implementation of the present disclosure, the second information includes a minimum volume of data associated with each of the at least one piece of characteristic information. In order to complete the training of the first node, in addition to indicate the required the expertise category/categories to the sixth node, the fifth node may also notify the data amount used for the training, one way is to carry a minimum volume of data in the first request, so that the sixth node can verify if it has enough data for supporting such training.

S902, the sixth node determines a first response based on the first request, where the first response is indicative of a capability of the sixth node for supporting the training of the first node.

Upon receiving the first request, the sixth node may analyze the first request and determine whether it can support the training required by the fifth node.

In a possible implementation of the present disclosure, since the first request includes the above mentioned first information and second information, the sixth node may then determine the required expertise category/categories based on the first information, then the sixth node may determine whether it has training data associated with the required expertise category/categories. Besides, upon determining that the sixth node has training data associated with the required expertise category/categories, the sixth node may also determine whether the volume of data is enough for supporting the training based on the minimum volume of data in the first request. As a response, the sixth node will generate the first response based on the above determinations. So the support of a required expertise category means that the sixth node not only has training data associated with this expertise category, but also the volume of such training data is enough for completing the training.

In a possible implementation of the present disclosure, the first response includes an indication of characteristic information supported by the sixth node, and an indication of the sixth node having required data for the training of the first node; accordingly, step S902 includes:
the sixth node determining the indication of characteristic information supported by the sixth node based on the first information, and
the sixth node determining the indication of the sixth node having required data for the training of the first node based on the second information.

Since the first information indicates the expertise category/categories requested by the fifth node, then the sixth node may determine the indication of characteristic information supported by the sixth node based on the first information. Still take an example where the indication of characteristic information supported by the sixth node is information of expertise category/categories supported by the sixth node (such as ID(s) of the expertise category/categories supported by the sixth node) for description, since the first information in the first request may simply include the description of the required expertise category/categories in some cases, so the sixth node may send the ID(s) corresponding to the description of the required expertise category/categories (those supported by the sixth node) in the first response, in this case, the indication of characteristic information supported by the sixth node would be the ID(s) corresponding to the description of the required expertise category/categories.

The indication of the sixth node having required data for the training of the first node may be, e.g., an indication indicating that a volume of training data of a required expertise category is enough for training of the first node. The sixth node may determine the indication of the sixth node having required data for the training of the first node based on the second information since the second information includes a minimum volume of data associated with each of the at least one piece of characteristic information.

Here it should be noted that the sixth node may or may not support all of the expertise categories requested by the fifth node, in the case where the sixth node supports all of the expertise categories requested by the fifth node, the sixth node may simply send an acknowledgment in the first response to the fifth node, such acknowledgement would be regarded as both of the indication of characteristic information supported by the sixth node and the indication of the sixth node having required data for the training of the first node, or, the sixth node may also send, in the first response, the volume of data associated with each required expertise category to the fifth node, or, the sixth node may also send, in the first response, the ID(s) of the required expertise category/categories, which is not limited in the present disclosure. In the case where the sixth node supports only some of the expertise categories requested by the fifth node, the sixth node may also take the ID(s) of the supported expertise category/categories and the volume of data associated with the supported expertise category/categories respectively as the indication of characteristic information supported by the sixth node and the indication of the sixth node having required data for the training of the first node, and send the same in the first response to the fifth node.

For example, if the fifth node sends in the first request with four IDs, ID1, ID2, ID3 and ID4, each ID is indicative of an expertise category and has its corresponding minimum volume of data for training (expressed as Volume 1, Volume 2, Volume 3, Volume 4), then the sixth node determines, based on the first request, that it has required data for expertise categories corresponding to ID3 and ID4, then the sixth node may use ID3 and ID4 as the indication of characteristic information supported by the sixth node, and/or use Volume 3 and Volume 4 as the indication of the sixth node having required data for the training of the first node, and then send the indication(s) to the fifth node. It should be noted that the first response serves to clarify the capability of the sixth node in supporting the training of the first node, so various forms could be taken, which is not limited in the present disclosure.

The first response is denoted as supported expertise category information in FIG. 9B, the step S902 corresponds to the step 1.2 shown in FIG. 9B. In FIG. 9B, the controller of the human feedback dataset may analyze the human feedback and determine whether the required expertise category/categories in the human feedback training data request can be supported by the human feedback dataset, i.e., for each required expertise category, the human feedback dataset contains sufficient (greater than or equal to the minimum volume indicated in the human feedback training data request, or a pre-determined threshold) training data associated with the required expertise category. If the human feedback training data request includes descriptions of the required expertise, the controller of human feedback dataset may resolve the descriptions and determine one or multiple expertise category/categories matching the required expertise descriptions.

S903, the sixth node sends the first response to the fifth node and the fifth node receives the first response from the sixth node.

Upon determining the first response, the sixth node can send the first response to the fifth node.

This step corresponds to the step 1.3 in FIG. 9B, where the controller of the human feedback dataset sends the supported expertise category information to the RLCF controller. The supported expertise category information may include: ID (corresponding to the above mentioned indication of characteristic information supported by the sixth node) and the volume of training data of each required expertise category which can be supported by the human feedback dataset (corresponding to the above mentioned indication of the sixth node having required data for the training of the first node).

S904, the fifth node performs, based on the first response, configuration on the first node and the sixth node for conducting the training.

Specifically, the fifth node performs the configuration on the first node and the sixth node based on the first response, that is, based on the information of expertise category/categories supported by the sixth node and the indication indicating that the volume of training data of each required expertise category which can be supported by the sixth node is enough for training of the first node included in the first response for conducting the training.

In a possible implementation of the present disclosure, the step of S904 includes:
the fifth node determining first configuration information and second configuration information of the first node based on the first response, where the first configuration information is indicative of a type of the first node, and the second configuration information is indicative of parameters for the training of the first node;
the fifth node configuring the first node based on the first configuration information and the second configuration information; and
the fifth node notifying the sixth node of configuration of the first node.

Specifically, the fifth node determines the first configuration information indicative of the type of the first node and the second configuration information indicative of parameters for the training of the first node based on the first response, configures the first node based on the first configuration information and the second configuration information, and then notifies the sixth node of the configuration of the first node.

In this implementation, the type of the first node and parameters for the training of the first node are used by the fifth node to configure the first node, thus enabling the trained first node to determine a more accurate reward prediction result.

In a possible implementation of the present disclosure, the determination of the first configuration information of the first node may include:
the fifth node determining the type of the first node based on the first response;
the notification of the sixth node of configuration of the first node includes:
   the fifth node notifying the sixth node of the type of the first node.

Specifically, the first configuration information is indicative of the type of the first node. Accordingly, the fifth node determines the first configuration information of the first node by determining the type of the first node and notifies the sixth node of the type of the first node. In a possible implementation of the present disclosure, the type of the first node may be predefined, so the fifth node may not notify the sixth node of the type of the first node.

The type of the first node may include a first type and a second type, where a node of the first type includes one integrated node associated with multiple pieces of characteristic information, a node of the second type includes multiple subnodes, and each of the multiple subnodes is associated with a piece of characteristic information among the multiple pieces of characteristic information. For example, the node of the first type may be the I-ERP in the RLCF system beta mentioned above, while the multiple subnodes (ERP A, ERP B, … ERP N shown in FIG. 7A) of the node of the second type are the multiple ERPs in the RLCF system alpha mentioned above. It should be noted that, as long as the functionality of the first node is realized, the specific way for implementing the first node is not limited, for example, when the first node is of the first type, it could also be implemented as distributed functional modules (e.g., distributed on different network elements); when the first node is of the second type, it could also be implemented as different functional modules integrated in one network element.

In this implementation, the type of the first node is determined based on the first response and notified the sixth node, which is conducive to configure the first node, and is thus conducive to improve the accuracy of the first node in determining a reward prediction result.

In a possible implementation of the present disclosure, the first response sent by the sixth node includes the indication of the characteristic information supported by the sixth node and the indication of the sixth node having required data for the training of the first node, and the determination of the first configuration information of the first node may further include:
the fifth node determining the number of candidate nodes for implementing the first node based on the indication of the characteristic information supported by the sixth node;
the determination of the second configuration information of the first node includes:
   the fifth node determining the second configuration information based on the indication of the sixth node having required data for the training of the first node.

Specifically, the information of expertise category/categories supported by the sixth node and the indication indicating that the volume of training data of each required expertise category which can be supported by the sixth node is enough for training of the first node included in the first response are respectively used by the fifth node to determine the number of candidate nodes for implementing the first node and the parameters for the training of the first node. As described above, the sixth node may return the indication of the supported expertise categories in the first response to the fifth node and the indication of the sixth node having required data for the training of the first node, so still take the above mentioned example, when the fifth node requests with ID1 to ID4, but the sixth node simply supports ID3 and ID4, then upon receiving the indication of characteristic information supported by the sixth node, the fifth node would know that only two IDs are supported by the sixth node, so for example, in the case of the RLCF system alpha, instead of using four candidate nodes as subnodes for implementing the first node, the fifth node simply uses two candidate nodes as subnodes for implementing the first node. Further, since the data amount may be a factor related to hyper parameters and initial parameters, the fifth node may determine, based on the indication of the sixth node having required data for the training of the first node, the second configuration information.

In this implementation, the indication of the characteristic information supported by the sixth node and the indication of the sixth node having required data for the training of the first node are used by the fifth node to configure the first node, therefore, the configured first node would be well-matched with the sixth node, and further enabling the trained first node to determine a more accurate reward prediction result.

In a possible implementation of the present disclosure, the second configuration information includes a first type of parameters and a second type of parameters, where the first type of parameters remains unchanged during the training of the first node and the second type of parameters is subject to updating based on training data provided by the sixth node during the training of the first node. For example, the first type of parameters (also referred to as hyper parameters) includes at least one of a structure of a neural network (such as deep neural network (DNN)) for the training of the first node, or an approach for the training of the first node (for example, a detailed RL algorithm of the RLCF system), the second type of parameters (also referred to as initial parameters) includes at least one of initial weights and bias for the neural network. In addition, the second type of parameters may further include links between the ERP(s) to be trained.

In this implementation, the parameters for configuring the first node are divided into different types, i.e., parameters remaining unchanged during the training of the first node and parameters subject to updating during the training of the first node, therefore, the configuration can be implemented in a more accurate way.

In a possible implementation of the present disclosure, the configuration of the first node based on the first configuration information and the second configuration information include:
the fifth node configuring a network element for implementing the first node and a connection between the sixth node and the first node based on the first configuration information and the second configuration information.

Specifically, since the first configuration information includes the number of candidate nodes for implementing the first node and the type of the first node, and the second configuration information includes the determined hyper-parameters and initial parameters, the fifth node configures the network element for implementing the first node and the connection between the sixth node and the first node based on the type of the first node, the number of candidate nodes for implementing the first node, and the determined hyper-parameters and initial parameters. Here the configuration of the connection between the sixth node and the first node serves to enable the sixth node to provide training data to the first node, so that the first node can implement the training. In the case where the first node is of the first type, the configuration may be to configure the connection between the sixth node and the first node (the integrated node), and in the case where the first node is of the second type, the configuration may be to configure connections between the sixth node and all subnodes of the first node.

In this implementation, the first configuration information and the second configuration information are used to configure the network element for implementing the first node and a connection between the sixth node and the first node, which is conducive to configure the first node, and is thus conducive to improve the accuracy of the first node in determining a reward prediction result.

After configuring the network element for implementing the first node and the connection between the sixth node and the first node, the sixth node and the first node can exchange training data for implementing the training. There would be various ways for the sixth node to send the training data to the first node. One way is to send the training data in response to a training request from the first node, and the other way is to send the training data directly, without the triggering of the request. The two ways will be described in detail as follows.

Manner 1. With training request

In this manner, the notification of the configuration of the first node includes:
the fifth node sending third information to the sixth node and the sixth node receiving the third information, where the third information is indicative of at least one path between the first node and the sixth node.

Specifically, the fifth node may send the third information (also referred to as routing information) indicative of at least one path between the first node and the sixth node to the sixth node, so that the data transmission can be perform between the first node and the sixth node based on the at least one path indicated by the third information.

In this implementation, information indicative of at least one path between the first node and the sixth node is sent by the fifth node to the sixth node, which is conducive to transmission of training data to the first node for the training of the first node, and is thus conducive to improve the accuracy of the first node in determining a reward prediction result.

The method may further include:
the first node sending a training request to the sixth node, where the training request is indicative of the characteristic information of the first node;
the sixth node receiving the training request from the first node;
the sixth node determining training data for the first node based on a type of the first node and the training request; and
the sixth node sending the training data to the first node based on the third information, to enable the first node to conduct the training based on the training data.

Specifically, the first node sends the training request to the sixth node, and then the sixth node, after receiving the training request from the first node, determines the training data for the first node based on the type of the first node (which may be predefined or notified by the fifth node) and the characteristic information of the first node indicated by the training request, and then sends the training data to the first node based on the third information, to enable the first node to conduct the training based on the training data.

In this implementation, the training data for the first node corresponding to the characteristic information of the first node is determined by the sixth node based on the type of the first node and the training request received from the first node, and sent to the first node based on the third information, which is conducive to training of the first node, and is thus conducive to improve the accuracy of the first node in determining a reward prediction result.

Manner 2. Without training request

It is also possible to implement the training of the first node without training request.

Specifically, in this manner, the notification of the configuration of the first node includes:
the fifth node sending fourth information to the sixth node and the sixth node receiving the fourth information, where the fourth information is indicative of a training dataset for the first node.

For the description of the third information, reference may be made to the first manner. In manner 2, in addition to the third information, the fifth node may also send fourth information (training data requirement in FIG. 9B) to the sixth node.

Specifically, for the first type of node, since the first node is an integrated node associated with multiple expertise categories supported by the sixth node, the fourth information may include ID(s) of the multiple expertise categories, so that the sixth node can locate training datasets corresponding to the multiple expertise categories based on the fourth information and send the training data in these training datasets to the first node; for the second type of node, the first node includes multiple subnodes, and each of the multiple subnodes is associated with an expertise category, so the fourth information may also include IDs of respective expertise categories associated with the multiple subnodes, that is, the sixth node knows a relationship between the subnodes and the expertise categories supported by the sixth node, so that the sixth node can determine which subnode corresponds to which expertise category, and can thus send training data in a training dataset corresponding to an expertise category to the corresponding subnode.

In this implementation, information indicative of the training dataset for the first node is sent by the fifth node to the sixth node, which is conducive to determine training data to be provided to the first node for the training of the first node, and is thus conducive to improve the accuracy of the first node in determining a reward prediction result.

In a possible implementation of the present disclosure, the fourth information may be further indicative of a format of data for the training of the first node, so that the sixth node prepares the training data for the first node to ensure that the training data satisfies the format requirement.

Here the format refers to the format of training data to be sent from the sixth node to the first node, the sixth node may be notified of such format so as to prepare corresponding training data. Besides, the indication of the format could also be carried in other information exchanged between the fifth node and the sixth node, which is not limited herein. The format could also be fixed, in that case, the format no longer needs to be indicated for the sixth node.

In this implementation, the format of data for the training of the first node is sent by the fifth node to the sixth node, which is conducive to transmission of training data to the first node for the training of the first node, and is thus conducive to improve the accuracy of the first node in determining a reward prediction result.

S905, the sixth node sends training data to the first node and the first node receives the training data from the sixth node, where the training data corresponds to characteristic information of the first node.

Depending on the type of the first node, the sending of the training data by the sixth node may be different.

In a case that the first node is of the first type which includes one integrated node associated with multiple expertise categories, the sixth node determines a first training dataset based on the fourth information and sends training data of the first training dataset to the first node based on the third information, to enable the first node to conduct the training based on the training data of the first training dataset.

In a case that the first node is of the second type which includes multiple subnodes with each of the multiple subnodes being associated with an expertise category, the sixth node determines a second training dataset based on the third information and sends training data of the second training dataset to each of the multiple subnodes based on the fourth information, to enable the first node to conduct the training based on the training data of the second training dataset.

Here the first training dataset and the second training dataset may both be included in the human feedback dataset controlled by the sixth node. The first training dataset includes multiple pieces of training data, each piece of training data includes a first data portion and a second data portion, the second data portion is indicative of an expertise category of the first data portion; the second training dataset includes multiple groups of training data, and each group of training data is associated with a predefined expertise category among the multiple expertise categories.

As described with reference to FIG. 7B, in the I-ERP case, each piece of training data in the first training dataset includes an observation segment portion and an additional expertise segment, the additional expertise segment is indicative of characteristic information of the observation segment. Here the observation segment portion corresponds to the first data portion mentioned above and the additional expertise segment corresponds to the second data portion mentioned above.

Therefore, the training dataset is determined by the sixth node based on the type of the first node and the third information, and sent to the first node based on the fourth information, to enable the first node to conduct the training based on training data of the training dataset. That is, the sixth node would prepare different kinds of training data for the first node, depending on its type. After determining the training data, the sixth node and the first node can exchange the training data by using the at least one path indicated by the third information. In this way, this implementation is conducive to improve the accuracy of the first node in determining a reward prediction result.

S906, the first node conducts the training based on the training data from the sixth node.

The above steps S901-S905 serve to make preparation for the training of the first node, and in step S906, the first node conducts the training based on the training data from the sixth node.

FIG. 9B shows a possible implementation of the above process. Specifically, the human feedback training data request is sent from the RLCF controller to the controller of the human feedback dataset, and as a response, the controller of the human feedback dataset analyzes the human feedback training data request and returns the supported expertise category information. The supported expertise category information may include ID(s) of expertise categories supported by the controller of the human feedback dataset and training data volume of each required expertise category which can be supported by the human feedback dataset. After receiving the supported expertise category information, the RLCF controller (e.g., a NET4AI controller) determines the number of candidate nodes for implementing the ERP, the type of the ERP (ERP in the above RLCF system alpha, or I-ERP), hyper-parameters (e.g., DNN structure, training approach, detailed algorithm), and initial parameters (e.g., initial weights and bias on neurons and links) of ERP(s) to be trained. For multiple ERPs in the RLCF system alpha, the associated expertise category (must be one of the required expertise categories) of each ERP should also be determined by the RLCF controller according to the supported expertise category information. Then the RLCF controller configures network element/elements to implement each ERP with the determined hyper-parameters and initial parameters, and configures the connection(s) or API(s) between the human feedback dataset and network element/elements implementing each ERP. The RLCF controller then notifies the human feedback dataset about the routing information to network element/elements implementing each ERP, and the training data requirements of each ERP. The training data requirements for each ERP may include: 1) ID of the ERP’s associated expertise category (for an I-ERP, this information is the ID(s) of all expertise category/categories that can be used for training the I-ERP), 2) format of the training data sample.

After the ERP training configuration, each ERP can be independently trained by the following steps: 1) the controller of the human feedback dataset prepares the training data for each ERP to ensure the training data requirements received in step 1.5, and sends the prepared training data to the target ERP according to the routing information received in step 1.5; 2) given the received prepared training data in step 2.1, each ERP can conduct its training procedure independently.

The step 1.1 of FIG. 9B corresponds to step S901 of FIG. 9A, the step 1.2 of FIG. 9B corresponds to step S902 of FIG. 9A, the step 1.3 of FIG. 9B corresponds to step S903 of FIG. 9A, the step 1.4 of FIG. 9B corresponds to step S904 of FIG. 9A, the training data feed path information shown in step 1.5 of FIG. 9B corresponds to the sending of the third information in step S904 of FIG. 9A, and the step 2.1 of FIG. 9B corresponds to step S905 of FIG. 9A, the step 2.2 of FIG. 9B corresponds to step S906 of FIG. 9A.

It should be noted that the training of the first node may be done off-line, that is, before the execution of the RLCF system, and the trained first node could be reused by different RLCF tasks. Besides, the first node could also be self-updated after the execution of the RLCF system. For example, when executing RLCF tasks initiated by the RL customer, the RL customer may provide feedback data, such feedback data may be added to the human feedback dataset controlled by the sixth node, so that the training dataset for the first node is updated, then the training of the first node could be done again to improve its performance.

In the data processing method, by performing configuration on the first node and the sixth node based on the first response indicative of a capability of the sixth node for supporting the training of the first node, and conducting training of the first node based on the training data corresponding to the characteristic information of the first node, the first node trained by training data associated with different expertise categories can provide more accurate reward prediction, that is, the accuracy of the first node in determining a reward prediction result is improved.

In the above ERP training procedure, by virtue of the interaction between the fifth node and the sixth node, the fifth node can perform configuration based on the capability of the sixth node, thus making the first node and the sixth node prepared for the training and further enabling the trained first node to determine a more accurate reward prediction result. In addition, the training data for the first node corresponding to the characteristic information of the first node is received from the first node and used to conduct the training, which is conducive to improve the accuracy of the first node in determining a reward prediction result.

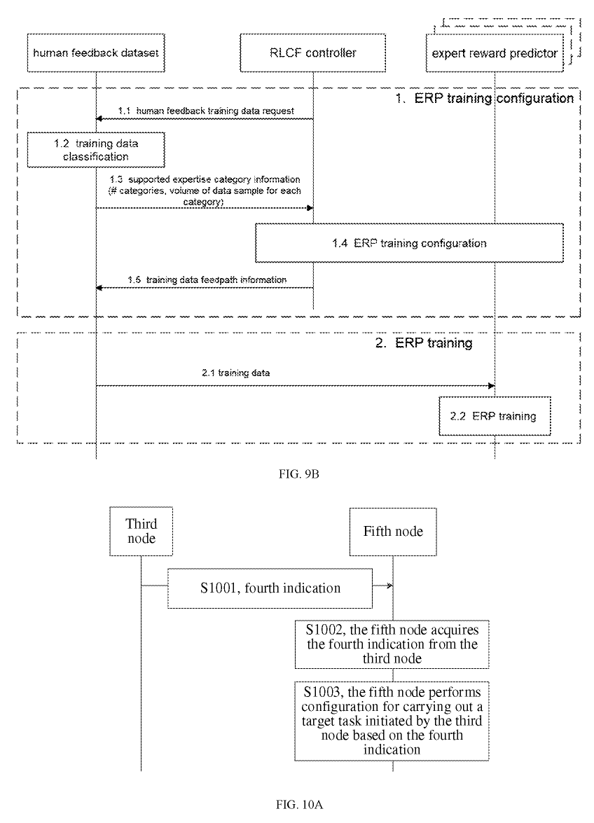

As described above, after the training of the first node, the RLCF controller (the fifth node) may configure corresponding network elements, so that they could be prepared for the later execution of the whole RLCF system. In the following, the configuration procedure will be described with reference to FIGS. 10A and 10B.

FIG. 10A is a flowchart of a second data processing method according to one or more embodiments of the present disclosure. FIG. 10B is also a possible implementation corresponding to the process shown in FIG. 10A, in which the subject bodies are denoted as RL customer, RL algorithm, EC, ERP and RLCF controller, and the information exchanged between different entities are also described with different names. However, the principles shown in both figures are similar. The method can be implemented by the third node (the RL customer), the second node (the RL algorithm), the fourth node (EC), the first node (ERP(s)) and the fifth node (the RLCF controller) of the RLCF system. As shown in FIG. 10A, the method can include the following steps.

S1001, a third node sends a fourth indication to a fifth node, where the fourth indication is indicative of a type of feedback data about a first observation provided by the third node.

Specifically, the fourth indication sent by the third node to the fifth node is indicative of the type of feedback data about the first observation provided by the third node to the fifth node. Here the first observation is indicative of a state of an environment obtained in response to an action of a second node, during the execution of the RLCF system, the second node may output an action to the environment, then the state of the environment may change in response to the action, so the third node will give an observation (the first observation) indicative of the state of the environment to the first node/the fourth node, meanwhile, the third node will also provide feedback data about the first observation to the fourth node, so as to enable the first node to determine a first prediction (reward prediction) for the action of the second node. Therefore, the feedback data provided by the third node serves to the determination of the final reward prediction for the action of the second node, so during the configuration procedure, the third node may notify the type of the feedback data to the fifth node, so that the fifth node can configure related nodes with such type.

In a possible implementation of the present disclosure, the type of the feedback data includes a first feedback type and a second feedback type, where the first feedback type of the feedback data is indicative of an evaluation of the third node on an observation, and the second feedback type of the feedback data is indicative of characteristic information of the third node. Specifically, the feedback data of the first feedback type may be a reward based feedback in which the value of the feedback data can be interpreted as a reward determined by the customer according to the observation, and the feedback data of the second feedback type may be a non-reward based feedback in which the value of the feedback data may not be interpreted as a reward form, but can represent the expertise category/categories of the third node.

In a possible implementation of the present disclosure, for example, before the sending of the fourth indication, the third node may send a third request to the fifth node, where the third request is indicative of description information corresponding to the target task. Specifically, the third node sends the third request indicative of description information corresponding to the target task to the fifth node to notify the fifth node of the description information corresponding to the target task, where the description information corresponding to the target task may include problem descriptions or specifications of the target task. Accordingly, the fifth node receives the third request sent by the third node. In this case, the sending of the third request may be regarded as the initiation of the target task. In a possible implementation, the third request may be further indicative of performance requirements for execution of the target task. The performance requirements may include, e.g., a convergence time threshold, a minimum prediction accuracy requirement and the like.

In this implementation, the third request indicative of the description information corresponding to the target task is sent from the third node to the fifth node, which is conducive to carry out the target task.

S1002, the fifth node acquires the fourth indication from the third node.

In a possible implementation of the present disclosure, the third node may send the type of the feedback data autonomously without being triggered by the second request from the fifth node, so the fifth node acquires the fourth indication directly.

In a possible implementation of the present disclosure, the fifth node sends, to the third node, a second request used for requesting the type of the feedback data, so as to query the type of feedback data about the first observation provided by the third node for performing configuration for carrying out a target task initiated by the third node later, the system for executing the target task can be well configured.

In a possible implementation of the present disclosure, the second request may further be used for requesting at least one of items: a format of the feedback data, a frequency at which the third node provides the feedback data or an interface required by the third node; the fourth indication is further indicative of at least one of the items requested by the fifth node.

In this implementation, the fifth node sends, to the third node, the second request used for requesting at least one of items: the format of the feedback data, the frequency at which the third node provides the feedback data or the interface required by the third node, so as to perform the configuration for carrying out the target task initiated by the third node based on these items in a more flexible way, the system for executing the target task can be well configured.

S1003, the fifth node performs configuration for carrying out the target task initiated by the third node based on the fourth indication.

Specifically, upon receiving the type of the feedback data from the third node, the fifth node can perform configuration for carrying out the target task initiated by the third node based on the type of feedback data about the first observation provided by the third node. Here the configuration may include, e.g., the choose of the functional nodes, the operations of corresponding functional nodes, and the connections between related functional nodes, all that is necessary for the subsequent execution of the RLCF system may be configured in this step.

In a possible implementation of the present disclosure, when the third node simply provides the type of feedback data to the fifth node, the fifth node may determine the related functional nodes, their operations and connections therebetween, without considering the specific requirements related to the target task. Such determination may be made, for example, based on historical data, which nodes have been involved in processing the same type of feedback data.

In a possible implementation of the present disclosure, when the third node sends, in addition to the fourth indication, the third request indicative of description information corresponding to the target task, the fifth node can then perform the configuration based on the type of feedback data and the description information indicated by the third node.

For example, the configuration may be performed as:
the fifth node determining, based on the description information corresponding to the target task, a first node and a second node for carrying out the target task;
the fifth node determining, based on the type of the feedback data and the first node, operations performed by the first node, the second node and a fourth node for carrying out the target task, where the fourth node is used for providing a prediction of an observation provided by the third node;
the fifth node configuring network elements and connections for implementing the operations performed by the first node, the second node and the fourth node based on the operations performed by the first node, the second node and the fourth node; and
the fifth node notifying, based on the network elements and connections for implementing the operations performed by the first node, the second node and the fourth node, the third node of the configuration for carrying out the target task.

Specifically, the fifth node determines, based on the problem descriptions or specifications of the target task in the description information, the first node and the second node for carrying out the target task, for example, the type of the first node (I-ERP or multiple ERPs) and the specific algorithm implemented by the second node. Then, the fifth node determines, based on the type of the feedback data and the first node, the RLCF execution procedure for executing the target task, in particular, the operations performed by the first node, the second node and the fourth node for carrying out the target task. The operations performed by the first node, the second node and the fourth node are then be used by the fifth node to configure network elements and connections for implementing the operations performed by the first node, the second node and the fourth node, based on which the configuration for carrying out the target task is notified the third node. Here the operations of nodes not only include the execution logic related to nodes, but also include specific algorithms implemented by the nodes and related parameters used in the algorithms, for example, the configuration of the operations of the second node may also include configuring hyper-parameters of the algorithm implemented by the second node since the hyper-parameters are related to the description information, the configuration of the operations of the fourth node may also include the setting of a preset classification algorithm in the fourth node. Besides, the configuration of the operations here may also include the configuration of the scheduled starting time for the applied RLCF execution procedure.

Further, the RLCF execution procedure may be implemented in various ways (which will be elaborated later), so the fifth node may configure the related nodes according to the specific procedure determined. Besides, the fourth node may itself provide a prediction for an observation provided by the third node, or may help providing such prediction, so the operations performed by the fourth node and the specific algorithm used by the fourth node (e.g., a classification algorithm used by the fourth node and parameters of the classification algorithm) may also be configured in this step.

In this implementation, by determining the first node and the second node for carrying out the target task, determining the operations performed by the first node, the second node and the fourth node, configuring, by the fifth node, the network elements and the connections for implementing the operations performed by the first node, the second node and the fourth node, and notifying the third node of the configuration for carrying out the target task, the system for executing the target task can be well configured.

In a possible implementation of the present disclosure, the configuration of the network elements and connections for implementing the operations performed by the first node, the second node and the fourth node includes:
the configuration of the network elements for implementing the operations performed by the first node, the second node and the fourth node;
the configuration of connections between the first node and a network element implementing the second node, connections between the first node and a network element implementing the fourth node and connections between the first node and the third node;
the configuration of connections between the fourth node and a network element implementing the first node, connections between the fourth node and a network element implementing the second node and connections between the fourth node and the third node; and
the configuration of connections between the second node and a network element implementing the first node, connections between the second node and a network element implementing the fourth node, connections between the second node and the third node.

The configuration of the network elements serves to determine the network elements for implementing the first node, the second node and the fourth node, and configuration of the connections serves to make the network elements prepared for implementing the operations. It should be noted that the configuration of the connections shown above cover all possible connections among the first node, the second node, the third node and the fourth node, however, it is also possible to simply configure some of the connections, depending on the interactions among these node, which is not limited herein. Besides, although the nodes are described with different serial numbers, some of them may be integrated into one node, in that case, one network element would be sufficient for implementing these integrated nodes.

In a possible implementation of the present disclosure, the determination of the first node for carrying out the target task includes:
determining, by the fifth node based on the description information corresponding to the target task, at least one candidate node which has carried out a historical task as the first node, where a similarity between the historical task and the target task is above a preset threshold.

Specifically, historical data of the historical task is used here to select the first node. It is possible that some candidate nodes have already participated in executing similar task, so these candidate nodes carrying out the historical task having a similarity above the preset threshold with the target task can be determined by the fifth node as the first node. Here the preset threshold is a value for characterizing the similarity between different tasks and can be set according to actual situations, which is not limited herein.

In this implementation, since the first node is determined to be the at least one candidate node which has carried out the historical task having a similarity with the target task that is above a preset threshold, the reuse of such first node makes the configuration much easier.

In a possible implementation of the present disclosure, the determination of the first node for carrying out the target task includes:
determining, by the fifth node based on the description information corresponding to the target task, a type of the first node, where the type of the first node includes a first type and a second type, where a node of the first type includes one integrated node associated with multiple pieces of characteristic information, a node of the second type includes multiple subnodes, and each of the multiple subnodes is associated with a piece of characteristic information among the multiple pieces of characteristic information;
upon determining that the first node is of the second type, determining, by the fifth node, all available candidate nodes as the subnodes of the first node.

Specifically, for the description of the type for the first node, reference may be made to the foregoing embodiments. Here the determination of the type may take several factors into account, for example, possible processing capability that may be required by the description information, availability of the candidate nodes, etc. In the case where the I-ERP is chosen, it is possible to choose all available candidate nodes as the subnodes of the first node.

In this implementation, by determining the type of the first node based on the description information corresponding to the target task, the system for executing the target task can be well configured.

After the connections and network elements are configured, the fifth node may notify the third node of the configuration for carrying the target task, so that the third node could interact with related nodes in the subsequent RLCF execution procedure.

In a possible implementation of the present disclosure, the fifth node sends a third configuration notification to the third node, where the third configuration notification is indicative of the network element for implementing the operations performed by the first node and a connection between the third node and the first node, and consequently, the third node receives the third configuration notification from the fifth node. This may be applicable to the case where the third node simply interacts with the first node.

In this implementation, the third configuration notification indicative of the network element for implementing the operations performed by the first node or the fourth node and the connection between the third node and the first node or the fourth node is sent by the fifth node to the third node, the third node of the system for executing the target task can be well configured.

In a possible implementation of the present disclosure, sending, by the fifth node, a third configuration notification to the third node, where the third configuration notification is indicative of the network element for implementing the operations performed by the fourth node and a connection between the third node and the fourth node, and consequently, the third node receives the third configuration notification from the fifth node. This may be applicable to the case where the third node simply interacts with the fourth node.

In addition, the third configuration notification is further indicative of execution logic related to the third node. After receiving the third configuration notification, the third node performs configuration based on the third configuration notification.

It should be noted that in some cases, the third node may not only interact with the first node or the fourth node, it may also need to know the location of the second node, since the second node is chosen by the fifth node. In this case, the third configuration notification may be further indicative of the network element for implementing the operations performed by the second node and a connection between the third node and the second node.

In addition to the third configuration notification, the fifth node may also notify other nodes, including the first node, the second node and the third node with their corresponding operations.

In a possible implementation of the present disclosure, the fifth node respectively sends a first configuration notification, a second configuration notification and a fourth configuration notification to the first node, the second node and the fourth node, where the first configuration notification, the second configuration notification and the fourth configuration notification are respectively indicative of operations performed by the first node, the second node and the fourth node for carrying out the target task, where the operations performed by the first node, the second node and the fourth node are determined by the fifth node based on the description information corresponding to the target task and the type of the feedback data. After receiving the first configuration notification, the second configuration notification and the fourth configuration notification, the first node, the second node and the fourth node perform configuration based on the first configuration notification, the second configuration notification and the fourth configuration notification respectively.

It should be noted that, as described above, some of the nodes can be integrated into one node, so in that case, one configuration notification would be sufficient for the nodes integrated as one node. For example, the first node and the fourth node are integrated as one node, then the first configuration notification and the fourth configuration notification can be integrated into one configuration notification.

FIG. 10B shows a possible implementation of the above process. Specifically, in step1, the RL customer sends an RLCF problem resolve request (corresponding to the third request above) to the RLCF controller to trigger the execution of an RLCF task (the target task). The RLCF problem resolve request may include information of the RLCF problem (or general AI problem) to be solved, e.g., the problem descriptions or specifications, or further include performance requirements of the RLCF task execution, e.g., convergence time threshold, minimum prediction accuracy requirement.

After receiving the RLCF problem resolve request, in steps 2 and 3, the RLCF controller sends a customer feedback info request (corresponding to the second request above) to the RL customer to query the customer feedback information (corresponding to the fourth indication above). After receiving the customer feedback info request, the RL customer sends customer feedback information to the RLCF controller. The customer feedback information includes all customer feedback information queried in the customer feedback info request.

In step 4, the RLCF controller then analyzes the received customer feedback information to determine the type of customer feedback (corresponding to the feedback data above) involved in the RLCF task. The types of customer feedback could be reward based feedback or non-reward based feedback as described above. Given the determined type of customer feedback, the RLCF controller resolves the received information of the RLCF problem in step 1, and determines the following:
hyper-parameters of the RL algorithm used for the RLCF task to solve the request RLCF problem, the applied RLCF system for the RLCF task, i.e., either RLCF system alpha or RLCF system beta, the trained ERP(s) involved in the RLCF task;
the trained ERP(s) involved in the RLCF task can be selected according to the historical data (e.g., the trained ERP(s) involved in past RLCF task(s) which solves the same or similar RLCF problem), or by default selecting all available ERPs if the RLCF system alpha is applied;
the applied RLCF execution procedure for executing the RLCF task. The applied RLCF execution procedure should be determined according to the applied RLCF system and the type of customer feedback. The scheduled starting time for the applied RLCF execution procedure should also be determined in this step.

the classification algorithm (and its associated parameters) executed by the EC. The classification algorithm (and its associated parameters) executed by the EC should be determined according to the type of customer feedback and the applied RLCF execution procedure.

Then in steps 5-8, the RLCF controller configures the network entity or entities implementing the selected ERP(s). The network entity or entities is configured by: interface(s)/connection(s) to network entity or entities implementing the RL algorithm, interface(s)/connection(s) to network entity or entities implementing the EC, interface(s)/connection(s) to the RL customer, ERP related execution logic and steps defined in applied RLCF execution procedure. RLCF controller selects and configures the network entity or entities to implement the EC. The network entity or entities is configured by: the determined classification algorithm and its associated parameters, interface(s)/connection(s) to network entity or entities implementing selected ERP(s), interface(s)/connection(s) to network entity or entities implementing the RL algorithm, interface(s)/connection(s) to the RL customer, EC related execution logic and steps defined in applied RLCF execution procedure. RLCF controller selects and configures the network entity or entities to implement the RL algorithm. The network entity or entities is configured by: hyper-parameters of the RL algorithm, interface(s)/connection(s) to network entity or entities implementing selected ERP(s), interface(s)/connection(s) to network entity or entities implementing the EC, interface(s)/connection(s) to the RL customer, RL algorithm related execution logic and steps defined in applied RLCF execution procedure. The RLCF controller confirms the configured RLCF task information to the RL customer. The RLCF task information includes: information of interface(s)/connection(s) between RL customer and the network entity or entities implementing RL algorithm, selected ERP(s), and EC; RL customer related execution logic and steps defined in applied RLCF execution procedure.

In the process of the configuration for carrying out the target task initiated by the third node, the feedback data provided by the third node can be leveraged to help configuring related nodes in a system for executing the target task, thereby making the system adaptive to the third node, and thus improving the accuracy of the execution of the RLCF task initiated by the third node.

In the above RLCF configuration procedure, because the configuration for carrying out the target task initiated by the third node is performed based on the fourth indication indicative of the type of feedback data about the first observation provided by the third node, the feedback data provided by the third node can be leveraged to help configuring a system for executing the target task.

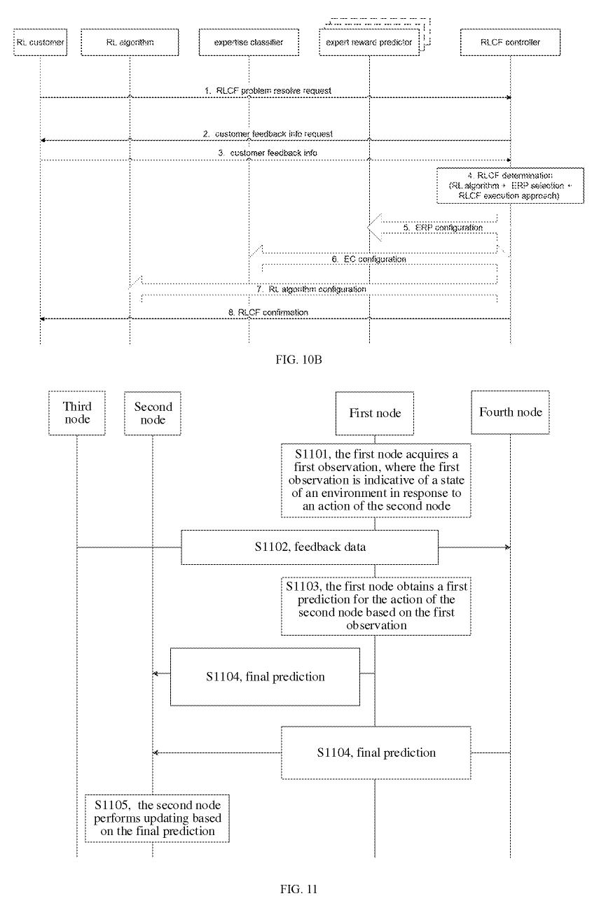

As described above, after the training of the first node and the configuration of the nodes, the execution of the whole RLCF system can be implemented. In the following, the execution procedure will be described with reference to FIGS. 11-15B.

FIG. 11 is a flowchart of a third data processing method according to one or more embodiments of the present disclosure. The method can be implemented by the first node (the ERP(s)), the second node (the RL algorithm), the third node (the RL customer) and the fourth node (the EC), which respectively referred as a first node, a second node, a third node and a fourth node in the description. As shown in FIG. 11, the method can include the following steps.

S1101, a first node acquires a first observation, where the first observation is indicative of a state of an environment in response to an action of a second node.

Here the first observation is indicative of a state of an environment obtained in response to an action of a second node, during the execution of the RLCF system, the second node may output an action to the environment, then the state of the environment may change in response to the action, so the third node will give an observation (the first observation) indicative of the state of the environment to the first node, meanwhile, the third node will also provide feedback data about the first observation to the fourth node, so as to enable the first node to determine a first prediction (reward prediction) for the action of the second node.

In a possible implementation of the present disclosure, the first node is associated with multiple pieces of characteristic information, and the first characteristic information is included in the multiple pieces of characteristic information. As described in the foregoing embodiments, the first node may be of a first type or a second type. A node of the first type includes one integrated node associated with multiple pieces of characteristic information, a node of the second type includes multiple subnodes, and each of the multiple subnodes is associated with a piece of characteristic information among the multiple pieces of characteristic information. That is, the node of the first type is the I-ERP in the RLCF system beta mentioned above, while the multiple subnodes of the node of the second type are the multiple ERPs in the RLCF system alpha mentioned above. Therefore, when the first node is of the first type, the first node as an integrated node may be associated with multiple pieces of characteristic information, and when the first node is of the second type, the subnodes of the first node may each associated with one piece of characteristic information.

In this implementation, the first node includes multiple subnodes, parameters of each of the multiple subnodes can be optimized/trained to be associated with a piece of characteristic information among the multiple pieces of characteristic information, thus each subnode could provide a reward prediction result based on characteristic information, and all together can provide a more accurate reward prediction result.

Besides, the characteristic information is used for characterizing the feature of the first node and may be expertise categories. In the following, the expertise category will be taken as an example of the characteristic information for description, however, it should be understood that the solution also applies when the characteristic information is other kinds of information.

In a possible implementation of the present disclosure, the first node is trained by using a first training dataset, the first training dataset includes multiple pieces of training data, each piece of training data includes a first data portion and a second data portion, the second data portion is indicative of characteristic information of the first data portion.

Specifically, the first training dataset may be included in the sixth node (or under the control of the sixth node), and include multiple pieces of training data, where each piece of training data includes an observation segment portion and an additional expertise segment, the additional expertise segment is indicative of characteristic information of the observation segment; the second training dataset includes multiple groups of training data, and each group of training data is associated with predefined characteristic information among the multiple pieces of characteristic information. And, the first node may be trained according to the steps S901-S906 of the data processing method as shown in FIG. 9 using the sixth node.

In this implementation, since the first node is trained by using the training data including the first data portion and the second data portion indicative of the characteristic information of the first data portion, the first node can provide a more accurate reward prediction result based on the first characteristic information indicated by the first indication and the feedback data about the first observation.

In a possible implementation of the present disclosure, the first node is trained by using a second training dataset, the second training dataset includes multiple groups of training data, and each group of training data corresponds to predefined characteristic information among the multiple pieces of characteristic information.

Specifically, the second training dataset may be included in the sixth node, and include multiple groups of training data, and each group of training data corresponds to predefined characteristic information among the multiple pieces of characteristic information. And, the first node may be trained according to the steps S901-S906 of the data processing method as shown in FIG. 9 using the sixth node.

In this implementation, because the first node is trained by using the training data corresponding to the predefined characteristic information among the multiple pieces of characteristic information, the reward prediction result provided by the first node would be more accurate.

To make the reception manner of the first observation by the first node diversified, in a possible implementation of the present disclosure, a third node directly sends the first observation, which is indicative of the state of the environment in response to the action of the second node, to the first node of the first type or each of the multiple subnodes of the first node of the second type.

In another possible implementation of the present disclosure, the third node sends the first observation, which is indicative of the state of the environment in response to the action of the second node, to a fourth node, and the fourth node, after receiving the first observation, broadcasts the first observation to the first node of the first type or each of the multiple subnodes of the first node of the second type. In this implementation, the first observation is received by the fourth node from the third node and broadcasted to each of the multiple subnodes of the first node, which reduces the processing pressure of the third node since the third node would no longer need to send the first observation to each of the subnodes, and enables the first node to determine a more accurate reward prediction result according to the first observation.

S1102, the third node sends feedback data about the first observation to the fourth node, and the fourth node receives the feedback data from the third node.

Specifically, the third node sends the feedback data about the first observation to the fourth node. A type of the feedback data includes a first feedback type and a second feedback type, where the first feedback type of the feedback data is indicative of an evaluation of the third node on an observation, and the second feedback type of the feedback data is indicative of characteristic information of the third node. Specifically, the feedback data of the first feedback type may be a reward based feedback in which the value of the feedback data can be interpreted as a reward determined by the customer according to the observation, and the feedback data of the second feedback type may be a non-reward based feedback in which the value of the feedback data cannot be interpreted as a reward form, but can represent the expertise category/categories of the third node.

Upon receiving the feedback data, the fourth node may itself calculate the final prediction, that is, a final reward for the action of the second node, or may help the first node to calculate the final prediction. Here the final prediction is related to first characteristic information of the third node in the environment, so generally, the fourth node may determine the first characteristic information of the third node based on the feedback data, in the case where the first node is of the first type, the fourth node may provide the first characteristic information of the third node to the first node so as to enable the first node to determine the final prediction; in the case where the first node is of the second type, the fourth node may also provide the first characteristic information of the third node to the first node so as to enable the first node to determine the final prediction; in the case where the first node is of the second type, or, the fourth node may determine the final prediction by itself, in either case, the final prediction may be sent to the second node from the first node or the fourth node. These different implementations would become clear from the following description.

It should be noted that the third node may not send feedback data to the fourth node in the current RL step, in this case, the fourth node may use historical feedback data (which may be corresponding to historical observations) for subsequent operations.

S1103, the first node obtains a first prediction for the action of the second node based on the first observation.

Upon acquiring the first observation, the first node may determine the first prediction. Here the first prediction may be the above mentioned final prediction, or it may also be a third prediction used for the fourth node to generate a fourth prediction as the final prediction.

S1104, the first node or the fourth node sends the final prediction to the second node, and the second node receives the final prediction for the action of the second node performed on the environment from the first node or the fourth node.

S1105, the second node performs updating based on the final prediction.

Upon receiving the final prediction, the second node can perform updating, e.g., update parameters related to the algorithm implemented by the second node, so as to get a better reward in the next round of execution.

Generally, the node which determines the final prediction and the node which sends the final prediction to the second node may be the same or different, they may be either the first node or the fourth node, depending on the type of the first node, and the specific execution logic. In order to elaborate the procedure more clearly, different cases for generating the final prediction, especially the interaction between the first node and the fourth node will be described with reference to different figures in the following.

Case I: the first node being of the first type

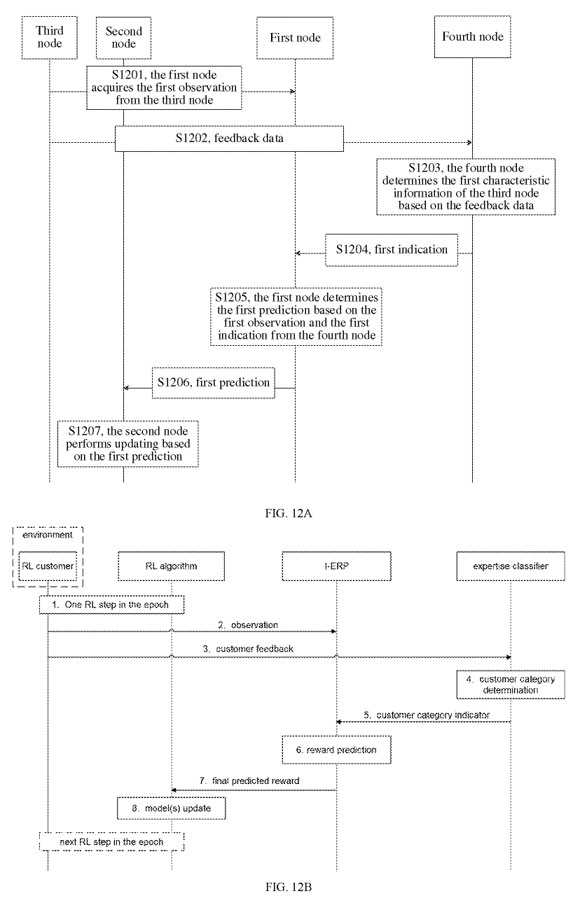

In this case, the first node is an I-ERP, as illustrated in FIG. 12A, the determination of the final prediction may include the following steps:

S1201, the first node acquires the first observation from the third node.

Reference may be made to relevant content in step S1101 for detailed description.

S1202, the fourth node receives feedback data from the third node.

Reference may be made to relevant content in step S1102 for detailed description.

S1203, the fourth node determines the first characteristic information of the third node based on the feedback data.

Specifically, the fourth node can use a preset classification algorithm which has already been configured during the above mentioned configuration procedure to determine the first characteristic information, for the configuration of this preset classification algorithm in the fourth node, reference may be made to relevant content in step S1003 for detailed description. The determination of the first characteristic information could be helpful for the first node to output a prediction more suitable for the third node.

In this implementation, the first characteristic information of the third node is determined based on the feedback data about the first observation from the third node, the feedback data provided by the third node can be leveraged to help identifying the first characteristic information of the third node.

In a possible implementation of the present disclosure, the classification algorithm used by the EC to determine the customer’s expertise can take one or multiple rounds to converge. Before the classification algorithm convergence, the determined first characteristic information can be represented as the weighted average of multiple expertise categories where each expertise category should be an expertise category associated with the first node.

S1204, the fourth node sends a first indication to the first node, where the first indication is indicative of the first characteristic information of the third node.

Since the first indication is indicative of the first characteristic information and determined by the fourth node based on feedback data about the first observation provided by the third node, the feedback data provided by the third node can be leveraged to help identifying the first characteristic information of the third node.

S1205, the first node determines the first prediction based on the first observation and the first indication from the fourth node.

Specifically, as one of the multiple pieces of characteristic information associated with the first node, the first characteristic information may also be an expertise category of the third node.

As described above in the training of the first node, since the first node (the I-ERP) is trained using a first training dataset which includes multiple pieces of training data, where each piece of training data includes a first data portion (observation segment portion) and a second data portion (an additional expertise segment), the second data portion is indicative of characteristic information of the first data portion, so the input data is therefore composed by the first observation and the first characteristic information indicated by the first indication, and the first node can consequently obtain the first prediction based on the first observation and the first characteristic information.

S1206, the first node sends the first prediction to the second node and the second node receives the first prediction.

S1207, the second node performs updating based on the first prediction.

Reference may be made to relevant content in step S1104 and S1105 for detailed description.

The above steps S1201-S1207 can be iteratively executed in each RL step. Here an RL step refers to one RL training step in an RL training epoch.

FIG. 12B is also a possible implementation corresponding to the process shown in FIG. 12A, in which the subject bodies are denoted as RL customer, RL algorithm, EC, and I-ERP, and the information exchanged between different entities are also described with different names. However, the principles shown in both figures are similar.

Specifically, in step 1 shown in FIG. 12B, the RL algorithm interacts with the environment to complete a traditional RL execution step without updating the parameters/model(s) of the RL algorithm. Then, in step 2, the RL customer obtains the current observation (corresponding to the first observation above) from the environment, and sends the observation to the I-ERP. Then in step 3, according to the current observation (and past observation(s) in some embodiments), the RL customer determines a customer feedback (corresponding to the feedback data above), and then sends the customer feedback to the EC. In some embodiments, the RL customer can choose not sending the customer feedback in the current RL step.

Then in step 4, the EC runs a classification algorithm to determine the expertise (corresponding to the first characteristic information above) of the RL customer according to the received customer feedback in step 3. The classification algorithm used by the EC to determine the customer’s expertise can take one or multiple rounds to converge. Before the classification algorithm convergence, the determined customer expertise can be represented as the weighted average of multiple expertise categories where each expertise category should be an ERP’s associated expertise category.

After determining the expertise of the RL customer, the EC sends a customer category indicator (corresponding to the first indication above) of the determined customer expertise to the I-ERP in step 5.

Then in step 6, the I-ERP concatenates the received observation in step 2, and the received customer expertise indicator in step 5 to form the input data, and conducts reward prediction using the input data to generate the final predicted reward (corresponding to the final prediction above). Then the I-ERP sends the calculated final predicted reward to RL algorithm in step 7 and the RL algorithm updates the parameters/model(s) according by the received final predicted reward in step 8.

Case II: the first node being of the second type

In this case, the first node is of the second type, and thus includes multiple subnodes, with each subnode being associated with a piece of characteristic information (an expertise category).

Generally, the first node or the fourth node may determine the final prediction, also, the feedback data used for determining the final prediction may be of the first feedback type and the second feedback type, where the first feedback type of the feedback data is indicative of an evaluation of the third node on an observation, and the second feedback type of the feedback data is indicative of characteristic information of the third node. Therefore, the determination of the final prediction may be described in the following for these situations.

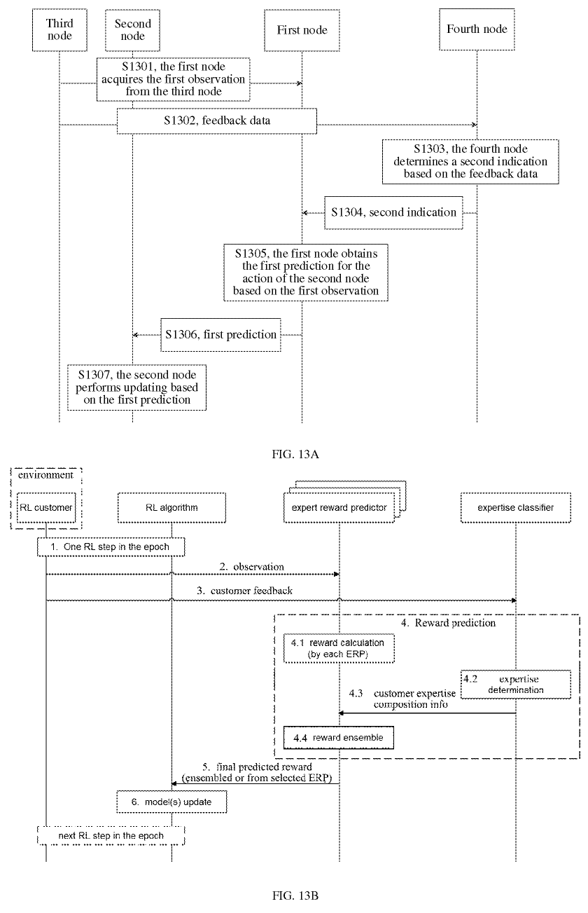

FIGS. 13A and 13B show the procedure where the final prediction (denoted as first prediction in this embodiment) is determined by the first node, and the feedback data is of the second feedback type (non-reward based feedback).

As illustrated in FIG. 13A, the determination of the final prediction may include the following steps:

S1301, the first node acquires the first observation from the third node.

Reference may be made to relevant content in step S1101 for detailed description.

S1302, the fourth node receives feedback data from the third node.

Reference may be made to relevant content in step S1102 for detailed description.

S1303, the fourth node determines a second indication based on the feedback data.

The second indication is used for indicating the first characteristic information of the third node. As one of the multiple pieces of characteristic information associated with the first node, the first characteristic information may also be an expertise category of the third node.

In a possible implementation of the present disclosure, the fourth node determines the expertise category of the third node based on the feedback data by running a classification algorithm. In a possible implementation of the present disclosure, the classification algorithm used by the fourth node to determine the expertise category/categories of the third node can take one or multiple rounds to converge.

In a possible implementation, the second indication may be simply indicative of the first characteristic information of the third node. In another possible implementation, the second indication may be indicative of both of the first characteristic information of the third node and the weight corresponding to the subnode. Here the weight may be determined by the fourth node by comparing the first characteristic information of the third node with the characteristic information associated with each subnode. For example, if the first characteristic information of the third node and the characteristic information associated with a subnode are the same, then the weight would be 1, else the weight would be 0.

S1304, the fourth node sends the second indication to the first node, and the first node receives the second indication.

Specifically, since the first node includes multiple subnodes, the fourth node may send the second indication to each of the multiple subnodes. In the case where the second indication is indicative of the first characteristic information of the third node, then all of the subnodes may receive the same second indication, while in the case that the second indication is further indicative of the weight corresponding to the subnode, then each subnode may receive its corresponding second indication, since such indication carries its weight.

S1305, the first node obtains the first prediction for the action of the second node based on the first observation.

Specifically, for each of the multiple subnodes, the subnode may determine a second prediction for the action of the second node based on the first observation, and determine the weight corresponding to the second prediction based on the second indication from the fourth node. In this way, the first prediction can be determined by the first subnode among the multiple subnodes to be the weighted sum of the second predictions of the multiple subnodes, which enables the first subnode to provide a more accurate reward prediction result. Here the second prediction is an initial prediction determined by each subnode, and needs to be weighted by using the weight.

Since the subnodes of the first node have been trained as described in the foregoing embodiments, based on training data from the second training dataset which is associated with predefined characteristic information, so the subnode is able to provide the second prediction for the first observation, and the second prediction of each subnode is related to its characteristic information.

It should be noted that, the multiple subnodes of the first node, when executing the above steps of the data processing method, may be implemented in the form of sub-modules of the first node.

In a possible implementation of the present disclosure, for each of the multiple subnodes, the second indication is indicative of the first characteristic information of the third node. After receiving the second indication, the subnode determines the weight corresponding to the second prediction based on the second indication and characteristic information associated with the subnode. For example, each subnode may compare its associated characteristic information (e.g., expertise category) with the first characteristic information of the third node, if the two are the same, then the weight would be 1, and if the two are not the same, the weight would be 0.

In this implementation, the second indication which is indicative of the first characteristic information of the third node is sent to the multiple subnodes for each of the multiple subnodes to determine the weight corresponding to the second prediction, the determined weight can thus be used for calibrating the initial second prediction, which enables the first subnode to provide a more accurate reward prediction result based on the calibrated second prediction.

After determining the weight corresponding to the second prediction based on the second indication from the fourth node, a first subnode among the multiple subnodes obtains a weighted sum of the second predictions of the multiple subnodes based on the second prediction of each of the multiple subnodes and the weight corresponding to the second prediction as the first prediction. Here the first subnode may be an anchor node predefined or selected by the fourth node from the multiple subnodes based on the similarity between the characteristic information associated with each subnode and the first characteristic information of the third node.

In this implementation, the first subnode, which acts as an anchor node and undertakes more interaction tasks than other subnodes, can be predefined or selected by the fourth node, which can simplify the operation of the data processing method.

In a possible implementation, each subnode may determine its own weighted prediction and then send its weighted sum to the first subnode, so that the first node can determine the whole weighted sum as the first prediction (the final prediction), for example, the subnode may multiply its second prediction with the weight to obtain its weighted prediction. In another possible implementation, each subnode may send its second prediction and corresponding weight to the first subnode, so that the first subnode determines the weighted sum of the second predictions of the multiple subnodes based on the second prediction of each of the multiple subnodes and the weight corresponding to the second prediction as the first prediction. In still another possible implementation, some of the multiple subnodes may calculate its own weighted prediction, while other do not, the first subnode may then determine the weighted sum based on what is received from other subnodes. The way for obtaining the weighted sum is not limited herein.

In a possible implementation of the present disclosure, for each of the multiple subnodes, the second indication is further indicative of the weight corresponding to the subnode. In this case, the determination of the weight is done by the fourth node as described above.

It should be noted that, regarding the determination of the second prediction by each of the multiple subnodes based on the second indication, the second indication may be received by the first node this time or previously, which is not limited in the present disclosure.

S1306, the first node sends the first prediction to the second node and the second node receives the first prediction.

Specifically, since the first subnode in step S1305 obtains the first prediction, it will send the first prediction to the second node.

In this way, the first prediction sent by the first node to the second node is used for the updating of the second node, so that the parameters/model(s) of the second node updated according to the first prediction are more accurate.

S1307, the second node performs updating based on the first prediction.

Reference may be made to relevant content in step S1104 and S1105 for detailed description.

The above steps S1301-S1307 can be iteratively executed in each RL step. Here an RL step refers to one RL training step in an RL training epoch. Besides, it should be noted that step S1303 and the determination of the second prediction by each subnode may be executed in parallel or in sequence, which is not limited herein.

FIG. 13B is also a possible implementation corresponding to the process shown in FIG. 13A, in which the subject bodies are denoted as RL customer, RL algorithm, EC, and ERP, and the information exchanged between different entities are also described with different names. However, the principles shown in both figures are similar.

Specifically, in step 1 shown in FIG. 13B, the RL algorithm interacts with the environment to complete a traditional RL execution step without updating the parameters/model(s) of the RL algorithm. Then, in step 2, the RL customer obtains the current observation (corresponding to the first observation above) from the environment, and sends the observation to the ERPs. Then in step 3, according to the current observation (and past observation(s) in some embodiments), the RL customer determines a customer feedback (corresponding to the feedback data above), and then sends the customer feedback to the EC. In some embodiments, the RL customer can choose not sending the customer feedback in the current RL step.

Then in step 4, the EC interacts with ERPs to predict the final prediction reward (corresponding to the first prediction above). Each ERP independently calculates an ERP predicted reward (corresponding to the third prediction above) according to the received current observation in step 2. The EC runs a classification algorithm (e.g., KNN) to determine the expertise (corresponding to the first characteristic information above) of the RL customer according to the received customer feedback in step 3. In some embodiments, the classification algorithm used by the EC to determine the customer’s expertise can take one or multiple rounds to converge. Before the classification algorithm convergence, the determined customer expertise can be represented as the weighted average of multiple expertise categories where each expertise category should be an ERP’s associated expertise category. Then the EC sends the customer expertise composition info to each ERP in step 4.3. The customer expertise composition info includes the weight of each ERP’s associated expertise category. For the converged classification algorithm, the weight sent to the ERP whose associated expertise category is same as the customer expertise is 1, and the weight(s) sent to other ERP(s) are 0. Then each ERP synchronizes the received customer expertise composition info with each other (e.g., sends the received customer expertise composition info to the anchor ERP), and the anchor ERP calculates the final predicted reward as the weighted average of all ERP predicted rewards. The weight applied to each ERP predicted reward in the calculation is equal to the weight received by the corresponding ERP in the customer expertise composition info. In some RL step where no customer expertise composition info is received (i.e., the step 4.2 is not executed due to no new customer feedback received in the RL step), the weight(s) received in the past RL step can be applied to calculate the final predicted reward.

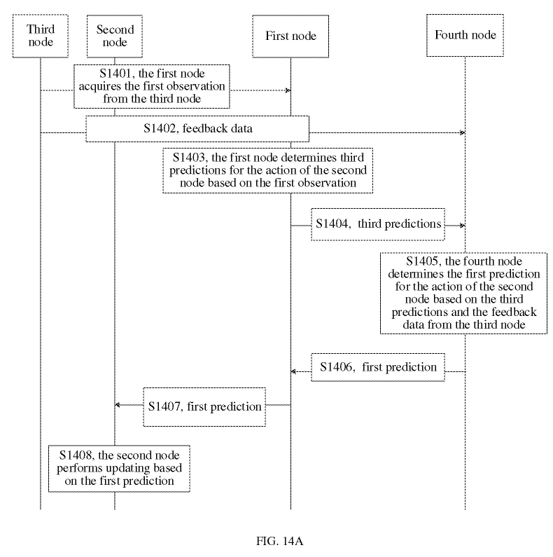

FIGS. 14A and 14B show the procedure where the final prediction (denoted as first prediction in this embodiment) is determined by the fourth node and sent to the second node by the first node, and the feedback data is of the first feedback type (reward based feedback).

As illustrated in FIG. 14A, the determination of the final prediction may include the following steps:

S1401, the first node acquires the first observation from the third node.

Reference may be made to relevant content in step S1101 for detailed description.

S1402, the fourth node receives feedback data from the third node.

Reference may be made to relevant content in step S1102 for detailed description.

S1403, the first node determines third predictions for the action of the second node based on the first observation.

Specifically, since the first node includes multiple subnodes, each subnode may determine a third prediction as an initial prediction. The determination of the third prediction by the subnode is the same as the determinate of the second prediction described in step S1305, which will not be repeated herein for the sake of clarity. These two predictions are denoted with different names simply because they are used in different procedures.

S1404, the first node sends the third predictions to the fourth node, and the fourth node receives the third predictions.

S1405, the fourth node determines the first prediction for the action of the second node based on the third predictions and the feedback data from the third node.

Specifically, the fourth node may determine a final prediction for the action of the second node based on the third prediction and the feedback data about the first observation from the third node, where the final prediction corresponds to first characteristic information of the third node in the environment.

In one or more embodiments of the present disclosure, the determination of the final prediction based on the third prediction and the feedback data about the first observation from the third node includes:
determining, by the fourth node, a similarity between the feedback data and the third prediction from each of the multiple subnodes; and
determining, by the fourth node, the final prediction based on the third prediction and the similarity between the feedback data and the third prediction from each of the multiple subnodes.

In this implementation, the final prediction is determined based on the third prediction and the similarity between the feedback data and the third prediction from each of the multiple subnodes, which is conducive to provide a more accurate reward prediction result.

For example, in a case that there is at least one third prediction whose similarity is greater than or equal to a preset threshold, the fourth node determines a third prediction with a highest similarity as the final prediction; and in a case that there is no third prediction whose similarity is greater than or equal to the preset threshold, the fourth node determines a weight corresponding to the third prediction of each of the multiple subnodes based on the similarity between the feedback data and the third prediction and calculates a weighted sum of the third predictions of the multiple subnodes based on the third prediction of each of the multiple subnodes and the weight corresponding to the third prediction as the final prediction. In a case where the fourth node does not receive the feedback data, historical feedback data is used by the fourth node to determine the final prediction.

In this implementation, the final prediction can be determined based on the third prediction in diversified ways, thus a more accurate reward prediction result is provided.

In the current case, the final prediction determined by the fourth node is referred to as the first prediction.

S1406, the fourth node sends the first prediction to the first node and the first node receives the first prediction from the fourth node.

In a possible implementation, the fourth node may select a first subnode from the multiple subnodes of the first node, and sends a third indication indicative of the first prediction to the first subnode. The first subnode can be selected based on the similarities of the third predictions of the multiple subnodes. For example, the first subnode, as an anchor node, may be a subnode whose third prediction has a highest similarity with the final prediction. In another possible implementation, the first subnode may also be predefined. Further, since the subnodes all know their respective third predictions, so in the case that the third prediction with a highest similarity is selected as the final prediction and the corresponding subnode is selected as the first subnode, then the fourth node may simply give a third indication to the first subnode, instead of sending the first prediction to the first subnode.

In this implementation, each of the multiple subnodes determines the third prediction and sends the third prediction to the fourth node, so that the fourth node can determine the third indication indicative of the first prediction (which would be a more accurate reward prediction result for the action of the second node) based on the third prediction and the feedback data and send the third indication to the first subnode among the multiple subnodes, which enables the first subnode to provide a more accurate reward prediction result. Further, the calculation is done by the fourth node, thereby reducing the processing pressure on the first node, besides, the first prediction can be sent from the first subnode to the second node, so the fourth node does not need to directly interact with the second node, the operation of the fourth node is thus simplified.

S1407, the first node sends the first prediction to the second node and the second node receives the first prediction.

Specifically, since the first subnode in step S1406 obtains the first prediction, it will send the first prediction to the second node.

S1408, the second node performs updating based on the first prediction.

Reference may be made to relevant content in step S1104 and S1105 for detailed description.

It should be noted that the fourth node may also directly send the first prediction to the second node.

The above steps S1401-S1408 can be iteratively executed in each RL step. Here an RL step refers to one RL training step in an RL training epoch.

FIG. 14B is also a possible implementation corresponding to the process shown in FIG. 14A, in which the subject bodies are denoted as RL customer, RL algorithm, EC, and ERP, and the information exchanged between different entities are also described with different names. However, the principles shown in both figures are similar.

Specifically, in step 1 shown in FIG. 14B, the RL algorithm interacts with the environment to complete a traditional RL execution step without updating the parameters/model(s) of the RL algorithm. Then, in step2, the RL customer obtains the current observation (corresponding to the first observation above) from the environment, and sends the observation to the ERPs. Then in step 3, according to the current observation (and past observation(s) in some embodiments), the RL customer determines a customer feedback (corresponding to the feedback data above), and then sends the customer feedback to the EC. In some embodiments, the RL customer can choose not sending the customer feedback in the current RL step.

Then in step 4, each ERP independently calculate an ERP predicted reward (corresponding to the third prediction above) according to the received current observation in step 2. Then Each ERP sends the ERP predicted reward to the EC. After receiving the ERP predicted rewards from all ERPs, the EC calculates the final predicted reward (corresponding to the first prediction above) according to the received ERP predicted rewards and the received customer feedback in step 3. In some embodiments, the EC compares similarity levels between each ERP predicted reward (received in 4.2) and the customer feedback (if no customer feedback received in this RL step, the past customer feedback value may be used). The ERP predicted reward with highest similarity level to the customer feedback is selected as the final predicted reward in this step. In some embodiments, if the similarity level(s) between the customer feedback and all ERP predicted reward(s) are lower than a pre-determined threshold, the final predicted reward can be determined as the weighted average of multiple ERP predicted rewards received in step 4.2. The weight assigned to each ERP predicted reward can be determined by the similarity level between the customer feedback value and the ERP predicted reward value.

After that, the EC sends the final predicted reward info to one of the ERPs, i.e., the anchor ERP. The final predicted reward info may include the value of final predicted reward. The anchor ERP can be pre-determined in the RLCF configuration procedure, or the ERP whose ERP predicted reward is selected as the final predicted reward. In the latter case, the final predicted reward info can only include an indicator. The anchor ERP who receives the final predict reward info in step 4.4 can forward the received final predicted reward (or the ERP predicted reward generated by itself) to the RL algorithm.

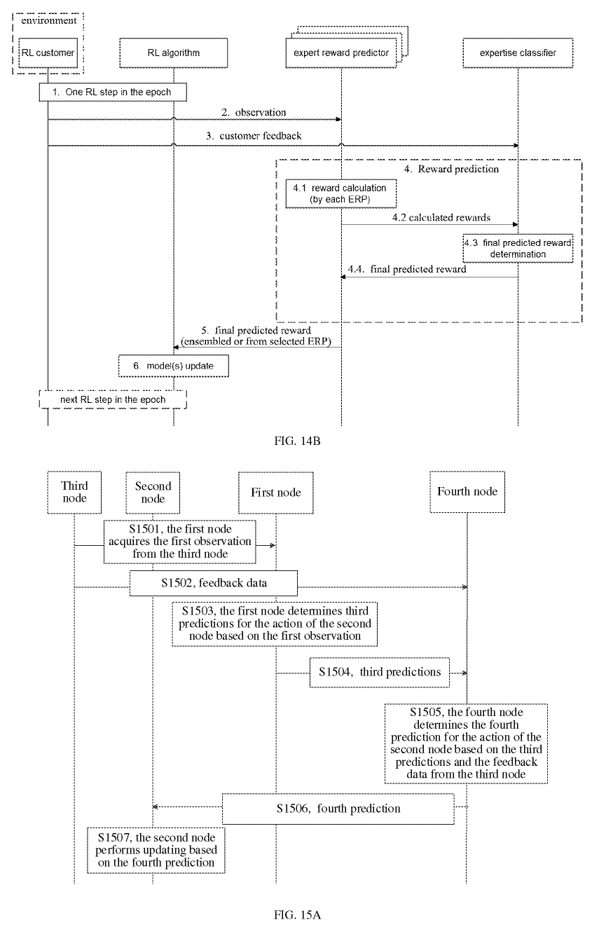

FIGS. 15A and 15B show the procedure where the final prediction (denoted as fourth prediction in this embodiment) is determined by the fourth node and sent to the second node by the fourth node, and the feedback data is of the first feedback type or the second feedback type (reward/non-reward based feedback).

As illustrated in FIG. 15A, the determination of the final prediction may include the following steps:

S1501, the first node acquires the first observation from the third node.

Reference may be made to relevant content in step S1101 for detailed description.

S1502, the fourth node receives feedback data from the third node.

Reference may be made to relevant content in step S1102 for detailed description.

S1503, the first node determines third predictions for the action of the second node based on the first observation.

Reference may be made to relevant content in step S1403 for detailed description.

S1504, the first node sends the third predictions to the fourth node, and the fourth node receives the third predictions.

S1505, the fourth node determines the fourth prediction for the action of the second node based on the third predictions and the feedback data from the third node.

In the case where the feedback data is of the first feedback type (reward based feedback), the fourth node first determines the first characteristic information of the third node based on the feedback data. For example, the fourth node determines the expertise category of the third node based on the feedback data by running a classification algorithm. In one or more embodiments of the present disclosure, the classification algorithm used by the fourth node to determine the expertise category/categories of the third node can take one or multiple rounds to converge.

Then for each of the multiple subnodes, the fourth node determines a weight corresponding to the third prediction of the subnode based on the first characteristic information of the third node and characteristic information associated with the subnode, and calculates a weighted sum of the third predictions of the multiple subnodes based on the third prediction of each of the multiple subnodes and the weight corresponding to the third prediction as the final prediction as the fourth prediction. Here the weight may be determined by the fourth node by comparing the first characteristic information of the third node with the characteristic information associated with each subnode. For example, if the first characteristic information of the third node and the characteristic information associated with a subnode are the same, then the weight would be 1, else the weight would be 0.

In the case where the feedback data is of the second feedback type (non-reward based feedback), for the determination of the fourth prediction, reference may be made to the determination of the first prediction in step S1405 for detailed description. The two predictions are all final predictions, the difference lies in that in the process shown in FIG. 14A, the first prediction as the final prediction is sent from the fourth node and then to the second node, but in the process shown in FIG. 15A, the fourth prediction as the final prediction is sent from the fourth node to the second node.

S1506, the fourth node sends the fourth prediction to the second node and the second node receives the fourth prediction.

S1507, the second node performs updating based on the fourth prediction.

In this implementation, each of the multiple subnodes determines the third prediction and sends the third prediction to the fourth node, so that the fourth node can determine the fourth prediction (which would be a more accurate reward prediction result for the action of the second node) corresponding to the first characteristic information of the third node in the environment based on the third prediction and the feedback data about the first observation provided by the third node, which enables the fourth node to provide a more accurate reward prediction result. Further, the calculation is done by the fourth node, thereby reducing the processing pressure on the first node, besides, the first prediction can be sent directly from the fourth node to the second node, thus reducing the signaling cost.

Reference may be made to relevant content in step S1104 and S1105 for detailed description.

FIG. 15B is also a possible implementation corresponding to the process shown in FIG. 15A, in which the subject bodies are denoted as RL customer, RL algorithm, EC, and ERP, and the information exchanged between different entities are also described with different names. However, the principles shown in both figures are similar.

Specifically, in step 1 shown in FIG. 15B, the RL algorithm interacts with the environment to complete a traditional RL execution step without updating the parameters/model(s) of the RL algorithm. Then, in step2, the RL customer obtains the current observation (corresponding to the first observation above) from the environment.

Then in step 3, the EC interacts with ERPs to predict the final prediction reward (corresponding to the fourth prediction above). The detailed interactions in this step include: the EC broadcasts the received observation in the current RL step to all ERPs. Each ERP independently calculates an ERP predicted reward according to the received current observation in step 3.1. Each ERP sends the ERP predicted reward (corresponding to the third prediction above) to the EC. After receiving the ERP predicted reward(s) from all ERP(s), the EC calculates the final predicted reward according to the received ERP predicted reward(s) in step 3.3, and the received customer feedback in step 2. If reward based feedback is applied, the EC calculates the final predicted reward by the same method described in step 4.3 shown in FIG. 14B. If non-reward based feedback is applied, the EC calculates the final predicted reward by the same method described in step 4.2 shown in FIG. 13B. The EC sends the calculated final predicted reward to the RL algorithm.

By obtaining the final prediction related to the first characteristic information of the third node in the environment and used for updating of the second node, the first node or the fourth node is enabled to provide a more accurate reward prediction result, which thus enables the second node to generate an action matching the first characteristic information of the third node.

It should be noted that some of the nodes may also be integrated into one node, or implemented on the same network element as different functional modules, then the information changed between these functional modules would thus be regarded as internal information exchange. The information changed between these functional modules and other nodes may also be integrated correspondingly. For example, the second node and one of the first node are implemented in one network element, then the information received by or sent from the second node and the first node would be regarded as going to or coming out from the same network element, and details will not be described herein for the sake of clarity.

Embodiments of the present disclosure provide methods for conducting reinforcement learning with customer feedback, and provide multiple ERPs, or integrated ERP (I-ERP) to represent preference/behaviors of different expertise categories. Besides, according to the customer feedback, the EC can dynamically classify the customer into an expertise category and adapt the final predicted reward (by the ERPs or I-ERP) to the customer’s expertise. In addition, the trained ERP(s) (or I-ERP) and the EC can be reused by different RLCF tasks.

Further, embodiments of the present disclosure provide new NFs and signaling to support RLCF and signaling between ERPs (I-ERP), the EC, and the network element (PSF) implementing RL algorithm/model. For example, the ERPs or I-ERP can be implemented as DP function (processing service function (PSF)) or CP function (in task control function (TCF)), the EC can be implemented as CP function (in TCF) or DP function (PSF).

According to the technical solution provided by the present disclosure, the ERP pre-trained by data from the customer’s expertise category can provide more accurate reward prediction than the general reward predictor. Besides, the final predicted reward can be dynamically determined according to the customer feedback, and a faster convergence speed than using massive customer feedback to re-train the general reward predictor is achieved.

In the above the RLCF execution procedure, by obtaining the first prediction related to the first characteristic information of the third node in the environment and used for updating of the second node, the first node can provide a more accurate reward prediction result, which enables the second node to generate an action matching the first characteristic information of the third node.

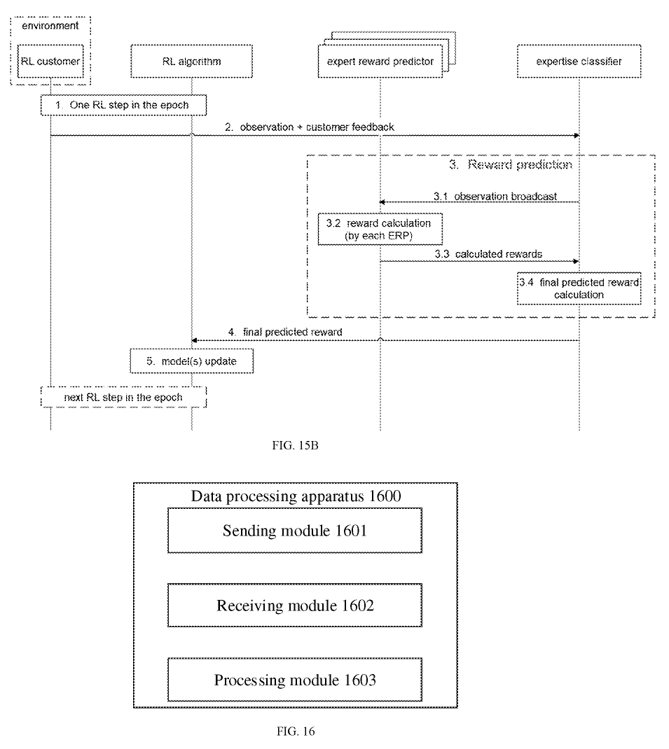

FIG. 16 is a schematic view of a data processing apparatus according to one or more embodiments of the present disclosure. The data processing apparatus may be an RLCF controller. As shown in FIG. 16, the data processing apparatus 1600 may include:
a sending module 1601, configured to send a first request to a sixth node, where the first request includes first information and second information, the first information is indicative of characteristic information for training of a first node, and the second information is indicative of a data attribute associated with the characteristic information;
a receiving module 1602, configured to receive a first response from the sixth node, where the first response is determined by the sixth node based on the first request and is indicative of a capability of the sixth node for supporting the training of the first node; and
a processing module 1603, configured to perform, based on the first response, configuration on the first node and the sixth node for conducting the training.

In a possible implementation of the present disclosure, the processing module 1603 is configured to:
determine first configuration information and second configuration information of the first node based on the first response, where the first configuration information is indicative of a type of the first node, and the second configuration information is indicative of parameters for the training of the first node; and
configure the first node based on the first configuration information and the second configuration information;

the sending module 1601 is configured to:
notify the sixth node of configuration of the first node.

In a possible implementation of the present disclosure, the processing module 1603 is configured to:
determine a type of the first node based on the first response, where the type of the first node includes a first type and a second type, where a node of the first type includes one integrated node associated with multiple pieces of characteristic information, a node of the second type includes multiple subnodes, and each of the multiple subnodes is associated with a piece of characteristic information among the multiple pieces of characteristic information;

the sending module 1601 is configured to:
notify the sixth node of the type of the first node.

In a possible implementation of the present disclosure, the first response includes an indication of characteristic information supported by the sixth node, and an indication of the sixth node having required data for the training of the first node;

the processing module 1603 is configured to:
determine a number of candidate nodes for implementing the first node based on the indication of the characteristic information supported by the sixth node;
determine the second configuration information based on the indication of the sixth node having required data for the training of the first node.

In a possible implementation of the present disclosure, the second configuration information includes a first type of parameters and a second type of parameters, where the first type of parameters remains unchanged during the training of the first node and the second type of parameters is subject to updating based on training data provided by the sixth node during the training of the first node.

In a possible implementation of the present disclosure, the first type of parameters includes at least one of a structure of a neural network for the training of the first node, and an approach for the training of the first node;

where the second type of parameters includes at least one of initial weights and bias for the neural network.

In a possible implementation of the present disclosure, the processing module 1603 is configured to:
configure a network element for implementing the first node and a connection between the sixth node and the first node based on the first configuration information and the second configuration information.

In a possible implementation of the present disclosure, the sending module 1601 is configured to:
send third information to the sixth node, where the third information is indicative of at least one path between the first node and the sixth node.

In a possible implementation of the present disclosure, the sending module 1601 is configured to:
send fourth information to the sixth node, where the fourth information is indicative of a training dataset for the first node.

In a possible implementation of the present disclosure, the fourth information further includes a format of data for the training of the first node.

In a possible implementation of the present disclosure, the first information includes at least one indication of at least one piece of characteristic information respectively, and the second information includes a minimum volume of data associated with each of the at least one piece of characteristic information.

The data processing apparatus may be applied to the fifth node as described in the above method embodiments shown in FIGS. 9A and 9B and or may be the fifth node as described in the above method embodiments shown in FIGS. 9A and 9B. It should be understood by a person skilled in the art that, the relevant description of the above modules in the embodiments of the present disclosure may be understood with reference to the relevant description of the data processing apparatus method in the embodiments of the present disclosure shown in FIGS. 9A and 9B.

FIG. 17 is a schematic view of another data processing apparatus according to one or more embodiments of the present disclosure. The data processing apparatus may be a human feedback dataset. As shown in FIG. 17, the data processing apparatus 1700 may include:
a receiving module 1701, configured to receive a first request from a fifth node, where the first request includes first information and second information, the first information is indicative of characteristic information for training of a first node, and the second information is indicative of a data attribute associated with the characteristic information;
a determining module 1702, configured to determine a first response based on the first request, where the first response is indicative of a capability of the sixth node for supporting the training of the first node; and
a sending module 1703, configured to send the first response to the fifth node.

In a possible implementation of the present disclosure, the first response includes an indication of characteristic information supported by the sixth node, and an indication of the sixth node having required data for the training of the first node;

where the determining module 1702 is configured to:
determine the indication of characteristic information supported by the sixth node based on the first information, and
determine the indication of the sixth node having required data for the training of the first node based on the second information.

In a possible implementation of the present disclosure, the receiving module 1701 is further configured to:
receive third information from the fifth node, where the third information is indicative of at least one path between the first node and the sixth node.

In a possible implementation of the present disclosure, the receiving module 1701 is further configured to:
receive a training request from the first node, where the training request is indicative of characteristic information of the first node;

the determining module 1702 is further configured to:
determine training data for the first node based on a type of the first node and the training request; and

the sending module 1703 is further configured to:
send the training data to the first node based on the third information, to enable the first node to conduct the training based on the training data.

In a possible implementation of the present disclosure, the receiving module 1701 is further configured to:
receive fourth information from the fifth node, where the fourth information is indicative of a training dataset for the first node.

In a possible implementation of the present disclosure, the determining module 1702 is further configured to:
upon determining that the first node is of a first type which includes one integrated node associated with multiple pieces of characteristic information, determine a first training dataset based on the third information; and
the sending module 1703 is further configured to:
send training data of the first training dataset to the first node based on the fourth information, to enable the first node to conduct the training based on the training data of the first training dataset;

the determining module 1702 is further configured to:
upon determining that the first node is of a second type which includes multiple subnodes with each of the multiple subnodes being associated with a piece of characteristic information among the multiple pieces of characteristic information, determine a second training dataset based on the third information; and
the sending module 1703 is further configured to:
send training data of the second training dataset to each of the multiple subnodes based on the fourth information, to enable the first node to conduct the training based on the training data of the second training dataset;

where the first training dataset includes multiple pieces of training data, each piece of training data includes a first data portion and a second data portion, the second data portion is indicative of characteristic information of the first data portion; the second training dataset includes multiple groups of training data, and each group of training data is associated with predefined characteristic information among the multiple pieces of characteristic information.

In a possible implementation of the present disclosure, the type of the first node is predefined or notified by the sixth node.

The data processing apparatus may be applied to the sixth node as described in the above method embodiments shown in FIGS. 9A and 9B and or may be the sixth node as described in the above method embodiments shown in FIGS. 9A and 9B. It should be understood by a person skilled in the art that, the relevant description of the above modules in the embodiments of the present disclosure may be understood with reference to the relevant description of the data processing apparatus method in the embodiments of the present disclosure shown in FIGS. 9A and 9B.

FIG. 18 is a schematic view of a further another data processing apparatus according to one or more embodiments of the present disclosure. The data processing apparatus may be ERP(s) shown in FIG. 7 or an I-ERP shown in FIG. 8. As shown in FIG. 18, the data processing apparatus 1800 may include:
a receiving module 1801, configured to receive training data from a sixth node, where the training data corresponds to characteristic information of the first node; and
a training module 1802, configured to conduct training based on the training data from the sixth node.

In a possible implementation of the present disclosure, the data processing apparatus 1800 further includes:
a sending module 1803, configured to send a training request to the sixth node, where the training request is indicative of the characteristic information of the first node.

In a possible implementation of the present disclosure, the first node is of a first type which includes one integrated node associated with multiple pieces of characteristic information;

the receiving module 1801 is configured to:
receive training data of a first training dataset from the sixth node, where the first training dataset includes multiple pieces of training data, each piece of training data includes a first data portion and a second data portion, the second data portion is indicative of characteristic information of the first data portion.

In a possible implementation of the present disclosure, the first node is of a second type which includes multiple subnodes with each of the multiple subnodes being associated with a piece of characteristic information among the multiple pieces of characteristic information;

the receiving module 1801 is configured to:
receive training data of a second training dataset from the sixth node, where the second training dataset includes multiple groups of training data, and each group of training data is associated with predefined characteristic information among the multiple pieces of characteristic information.

The data processing apparatus may be applied to the first node as described in the above method embodiments shown in FIGS. 9A and 9B and or may be the first node as described in the above method embodiments shown in FIGS. 9A and 9B. It should be understood by a person skilled in the art that, the relevant description of the above modules in the embodiments of the present disclosure may be understood with reference to the relevant description of the data processing apparatus method in the embodiments of the present disclosure shown in FIGS. 9A and 9B.

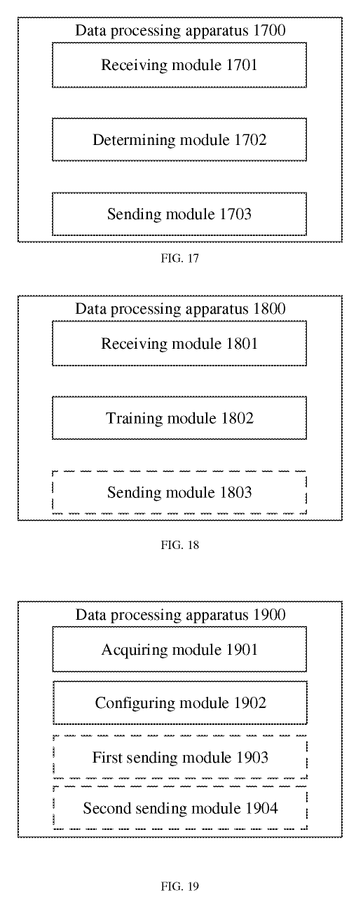

FIG. 19 is a schematic view of still another data processing apparatus according to one or more embodiments of the present disclosure. The data processing apparatus may be an RLCF controller. As shown in FIG. 19, the data processing apparatus 1900 may include:
an acquiring module 1901, configured to acquire a fourth indication from a third node, where the fourth indication is indicative of a type of feedback data about a first observation provided by the third node; and
a configuring module 1902, configured to perform, based on the fourth indication, configuration for carrying out a target task initiated by the third node.

In a possible implementation of the present disclosure, the data processing apparatus 1900 further includes:
a first sending module 1903, configured to send a second request to the third node, where the second request is used for requesting the type of the feedback data;
the acquiring module 1901 is configured to receive the fourth indication from the third node.

In a possible implementation of the present disclosure, the second request is used for requesting at least one of items: a format of the feedback data, a frequency at which the third node provides the feedback data or an interface required by the third node;

where the fourth indication is further indicative of at least one of the items requested by the fifth node.

In a possible implementation of the present disclosure, the acquiring module 1901 is configured to:
receive a third request from a third node, where the third request is indicative of description information corresponding to the target task.

In a possible implementation of the present disclosure, the configuring module 1902 is configured to:
determine, based on the description information corresponding to the target task, a first node and a second node for carrying out the target task;
determine, based on the type of the feedback data and the first node, operations performed by the first node, the second node and a fourth node for carrying out the target task, where the fourth node is used for providing a prediction of an observation provided by the third node;
configure network elements and connections for implementing the operations performed by the first node, the second node and the fourth node based on the operations performed by the first node, the second node and the fourth node; and
the data processing apparatus 1900 further includes:
   a second sending module 1904, configured to notify, based on the network elements and connections for implementing the operations performed by the first node, the second node and the fourth node, the third node of the configuration for carrying out the target task.

In a possible implementation of the present disclosure, the configuring module 1902 is configured to:
determine, based on the description information corresponding to the target task, at least one candidate node which has carried out a historical task as the first node, where a similarity between the historical task and the target task is above a preset threshold.

In a possible implementation of the present disclosure, the configuring module 1902 is configured to:
determine, based on the description information corresponding to the target task, a type of the first node, where the type of the first node includes a first type and a second type, where a node of the first type includes one integrated node associated with multiple pieces of characteristic information, a node of the second type includes multiple subnodes, and each of the multiple subnodes is associated with a piece of characteristic information among the multiple pieces of characteristic information;
upon determining that the first node is of the second type, determine all available candidate nodes as the subnodes of the first node.

In a possible implementation of the present disclosure, the second sending module 1904 is configured to:
send a third configuration notification to the third node, where the third configuration notification is indicative of the network element for implementing the operations performed by the first node and a connection between the third node and the first node; or,
send a third configuration notification to the third node, where the third configuration notification is indicative of the network element for implementing the operations performed by the fourth node and a connection between the third node and the fourth node.

In a possible implementation of the present disclosure, the second sending module 1904 is further configured to:
send a first configuration notification to the first node, where the first configuration notification is indicative of the operations performed by the first node;
send a second configuration notification to the second node, where the second configuration notification is indicative of the operations performed by the second node; and s
end a fourth configuration notification to the fourth node, where the fourth configuration notification is indicative of the operations performed by the fourth node.

In a possible implementation of the present disclosure, the type of the feedback data includes a first feedback type and a second feedback type, where the first feedback type of the feedback data is indicative of an evaluation of the third node on an observation, and the second feedback type of the feedback data is indicative of characteristic information of the third node.

The data processing apparatus may be applied to the fifth node as described in the above method embodiments shown in FIGS. 10A and 10B and or may be the fifth node as described in the above method embodiments shown in FIGS. 10A and 10B. It should be understood by a person skilled in the art that, the relevant description of the above modules in the embodiments of the present disclosure may be understood with reference to the relevant description of the data processing apparatus method in the embodiments of the present disclosure shown in FIGS. 10A and 10B.

FIG. 20 is a schematic view of yet another data processing apparatus according to one or more embodiments of the present disclosure. The data processing apparatus may be ERP(s) shown in FIG. 7 or an I-ERP shown in FIG. 8. As shown in FIG. 20, the data processing apparatus 2000 may include:
a receiving module 2001, configured to receive a first configuration notification from a fifth node, where the first configuration notification is indicative of operations performed by the first node for carrying out a target task initiated by a third node, where the operations are determined by the fifth node based on description information corresponding to the target task and a type of feedback data provided by the third node; and
a configuring module 2002, configured to perform configuration based on the first configuration notification.

The data processing apparatus may be applied to the first node as described in the above method embodiments shown in FIGS. 10A and 10B and or may be the first node as described in the above method embodiments shown in FIGS. 10A and 10B. It should be understood by a person skilled in the art that, the relevant description of the above modules in the embodiments of the present disclosure may be understood with reference to the relevant description of the data processing apparatus method in the embodiments of the present disclosure shown in FIGS. 10A and 10B.

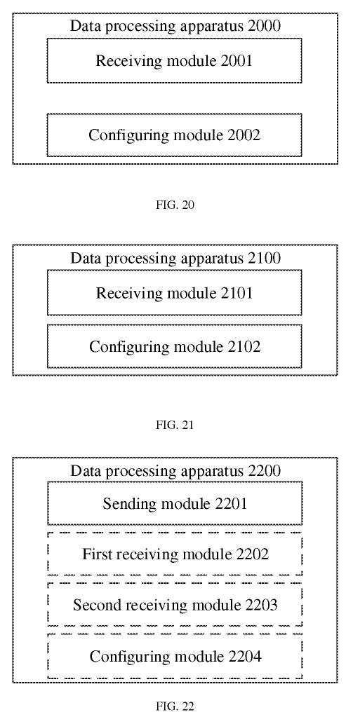

FIG. 21 is a schematic view of yet another data processing apparatus according to one or more embodiments of the present disclosure. The data processing apparatus may be an RL algorithm. As shown in FIG. 21, the data processing apparatus 2100 may include:
a receiving module 2101, configured to receive a second configuration notification from a fifth node, where the second configuration notification is indicative of operations performed by the second node for carrying out a target task initiated by a third node, where the operations are determined by the fifth node based on description information corresponding to the target task and a type of feedback data provided by the third node; and
a configuring module 2102, configured to perform configuration based on the second configuration notification.

The data processing apparatus may be applied to the second node as described in the above method embodiments shown in FIGS. 10A and 10B and or may be the second node as described in the above method embodiments shown in FIGS. 10A and 10B. It should be understood by a person skilled in the art that, the relevant description of the above modules in the embodiments of the present disclosure may be understood with reference to the relevant description of the data processing apparatus method in the embodiments of the present disclosure shown in FIGS. 10A and 10B.

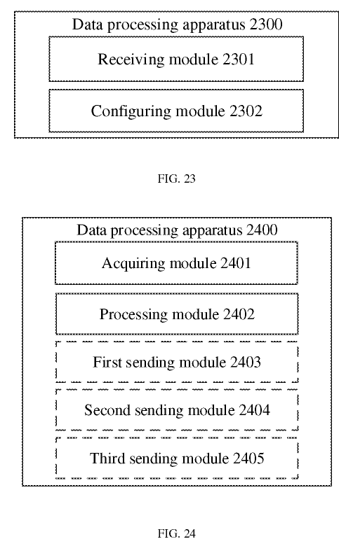

FIG. 22 is a schematic view of yet another data processing apparatus according to one or more embodiments of the present disclosure. The data processing apparatus may be an RL customer. As shown in FIG. 22, the data processing apparatus 2200 may include:
a sending module 2201, configured to send a fourth indication to a fifth node, to enable the fifth node to perform configuration for carrying out a target task initiated by the third node based on the fourth indication, where the fourth indication is indicative of a type of feedback data provided by the third node.

In a possible implementation of the present disclosure, the data processing apparatus 2200 further includes:
a first receiving module 2202, configured to receive a second request from the fifth node, where the second request is used for requesting the type of the feedback data.

In a possible implementation of the present disclosure, the second request is used for requesting at least one of items: a format of the feedback data, a frequency at which the third node provides the feedback data or an interface required by the third node;

where the fourth indication is further indicative of at least one of the items requested by the fifth node.

In a possible implementation of the present disclosure, the sending module 2201 is further configured to:
send a third request to the fifth node, where the third request is indicative of description information corresponding to the target task.

In a possible implementation of the present disclosure, the data processing apparatus further includes:
a second receiving module 2203, configured to receive a third configuration notification from the fifth node, where the third configuration notification is indicative of a network element for implementing operations performed by a first node and a connection between the third node and the first node; or, the third configuration notification is indicative of a network element for implementing operations performed by a fourth node and a connection between the third node and the fourth node; and
a configuring module 2204, configured to perform configuration based on the third configuration notification.

The data processing apparatus may be applied to the third node as described in the above method embodiments shown in FIGS. 10A and 10B and or may be the third node as described in the above method embodiments shown in FIGS. 10A and 10B. It should be understood by a person skilled in the art that, the relevant description of the above modules in the embodiments of the present disclosure may be understood with reference to the relevant description of the data processing apparatus method in the embodiments of the present disclosure shown in FIGS. 10A and 10B.

FIG. 23 is a schematic view of yet another data processing apparatus according to one or more embodiments of the present disclosure. The data processing apparatus may be an EC. As shown in FIG. 23, the data processing apparatus 2300 may include:
a receiving module 2301, configured to receive a fourth configuration notification from a fifth node, where the fourth configuration notification is indicative of operations performed by the fourth node for carrying out a target task initiated by a third node, where the operations are determined by the fifth node based on description information corresponding to the target task and a type of feedback data provided by the third node; and
a configuring module 2302, configured to perform configuration based on the fourth configuration notification.

The data processing apparatus may be applied to the fourth node as described in the above method embodiments shown in FIGS. 10A and 10B and or may be the fourth node as described in the above method embodiments shown in FIGS. 10A and 10B. It should be understood by a person skilled in the art that, the relevant description of the above modules in the embodiments of the present disclosure may be understood with reference to the relevant description of the data processing apparatus method in the embodiments of the present disclosure shown in FIGS. 10A and 10B.

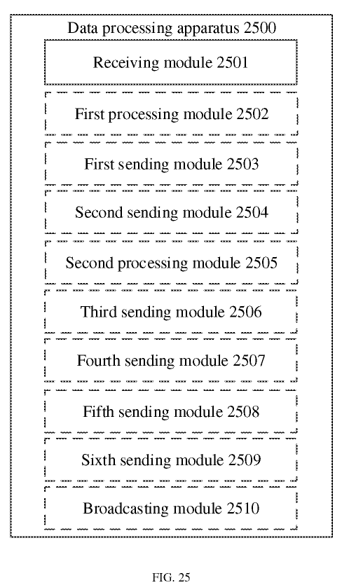

FIG. 24 is a schematic view of yet another data processing apparatus according to one or more embodiments of the present disclosure. The data processing apparatus may be ERP(s) shown in FIG. 7 or an I-ERP shown in FIG. 8. As shown in FIG. 24, the data processing apparatus 2400 may include:
an acquiring module 2401, configured to acquire a first observation, where the first observation is indicative of a state of an environment in response to an action of a second node; and
a processing module 2402, configured to obtain a first prediction for the action of the second node based on the first observation, where the first prediction is related to first characteristic information of a third node in the environment, and the first prediction is used for updating of the second node.

In a possible implementation of the present disclosure, the first node is associated with multiple pieces of characteristic information, and the first characteristic information is included in the multiple characteristic information.

In a possible implementation of the present disclosure, the processing module 2402 is configured to:
determine the first prediction based on the first observation and a first indication from the fourth node, where the first indication is indicative of the first characteristic information of the third node and determined by the fourth node based on feedback data about the first observation provided by the third node.

In a possible implementation of the present disclosure, the first node is trained by using a first training dataset, the first training dataset includes multiple pieces of training data, each piece of training data includes a first data portion and a second data portion, the second data portion is indicative of characteristic information of the first data portion.

In a possible implementation of the present disclosure, the first node includes multiple subnodes, each of the multiple subnodes is associated with a piece of characteristic information among the multiple pieces of characteristic information.

In a possible implementation of the present disclosure, the processing module 2402 is configured to:
for each of the multiple subnodes, determine a second prediction for the action of the second node based on the first observation, and determine a weight corresponding to the second prediction based on a second indication from a fourth node, where the second indication is indicative of the first characteristic information of the third node and determined by the fourth node based on feedback data about the first observation provided by the third node;
for a first subnode among the multiple subnodes, obtain a weighted sum of the second predictions of the multiple subnodes based on the second prediction of each of the multiple subnodes and the weight corresponding to the second prediction as the first prediction.

In a possible implementation of the present disclosure, the processing module 2402 is configured to:
for each of the multiple subnodes, determine the weight corresponding to the second prediction based on the second indication and characteristic information associated with the subnode.

In a possible implementation of the present disclosure, for each of the multiple subnodes, the second indication is further indicative of a weight corresponding to the subnode.

In a possible implementation of the present disclosure, the processing module 2402 is further configured to:
for each of the multiple subnodes, determine a third prediction for the action of the second node based on the first observation,

the data processing apparatus 2400 further includes:
a first sending module 2403, configured to, for each of the multiple subnodes, send the third prediction to a fourth node, to enable the fourth node to determine a third indication indicative of the first prediction based on the third prediction and feedback data about the first observation provided by the third node;
the acquiring module 2401 is configured to:
for a first subnode among the multiple subnodes, receive the third indication indicative of the first prediction sent by the fourth node.

In a possible implementation of the present disclosure, the first subnode is predefined or selected by the fourth node.

In a possible implementation of the present disclosure, the first prediction includes third predictions respectively determined by the multiple subnodes;

where the processing module 2402 is configured to:
for each of the multiple subnodes, determine a third prediction for the action of the second node based on the first observation;
and the data processing apparatus 2400 further includes:
a second sending module 2404, configured to, for each of the multiple subnodes, send the third prediction to the fourth node, to enable the fourth node to determine a fourth prediction for the action of the second node based on the third prediction and feedback data about the first observation provided by the third node, where the fourth prediction corresponds to the first characteristic information of the third node in the environment.

In a possible implementation of the present disclosure, the first node is trained by using a second training dataset, the second training dataset includes multiple groups of training data, and each group of training data corresponds to predefined characteristic information among the multiple pieces of characteristic information.

In a possible implementation of the present disclosure, the data processing apparatus 2400 further includes:
a third sending module 2405, configured to send the first prediction to the second node, to enable the updating of the second node.

In a possible implementation of the present disclosure, the acquiring module 2401 is configured to:
receive the first observation from the third node; or,
receive the first observation broadcasted by a fourth node.

The data processing apparatus may be applied to the first node as described in the above method embodiment shown in FIG. 11 and or may be the first node as described in the above method embodiment shown in FIG. 11. It should be understood by a person skilled in the art that, the relevant description of the above modules in the embodiments of the present disclosure may be understood with reference to the relevant description of the data processing apparatus method in the embodiment of the present disclosure shown in FIG. 11.

FIG. 25 is a schematic view of yet another data processing apparatus according to one or more embodiments of the present disclosure. The data processing apparatus may be an EC. As shown in FIG. 25, the data processing apparatus 2500 may include:
a receiving module 2501, configured to receive feedback data about a first observation from a third node, where the first observation is indicative of a state of an environment in response to an action of a second node.

In a possible implementation of the present disclosure, the first node includes multiple subnodes, each of the multiple subnodes is associated with a piece of characteristic information among the multiple pieces of characteristic information;

where the receiving module 2501 is further configured to:
receiving, by the fourth node, a third prediction from each of the multiple subnodes;

the data processing apparatus 2500 may further include:
a first processing module 2502, configured to determine a final prediction for the action of the second node based on the third prediction and the feedback data about the first observation from the third node, where the final prediction corresponds to first characteristic information of the third node in the environment.

In a possible implementation of the present disclosure, the first processing module 2502 is configured to:
determine a similarity between the feedback data and the third prediction from each of the multiple subnodes; and
determine the final prediction based on the third prediction and the similarity between the feedback data and the third prediction from each of the multiple subnodes.

In a possible implementation of the present disclosure, the first processing module 2502 is configured to:
in a case that there is at least one third prediction whose similarity is greater than or equal to a preset threshold, determine a third prediction with a highest similarity as the final prediction;
in a case that there is no third prediction whose similarity is greater than or equal to the preset threshold, determine a weight corresponding to the third prediction of each of the multiple subnodes based on the similarity between the feedback data and the third prediction and calculate a weighted sum of the third predictions of the multiple subnodes based on the third prediction of each of the multiple subnodes and the weight corresponding to the third prediction as the final prediction.

In a possible implementation of the present disclosure, the final prediction is a first prediction;

the first processing module 2502 is further configured to:
select a first subnode from the multiple subnodes based on the similarities of the third predictions of the multiple subnodes; and
the data processing apparatus 2500 may further include:
a first sending module 2503, configured to send a third indication indicative of the first prediction to the first subnode.

In a possible implementation of the second aspect, the final prediction is a fourth prediction;

the data processing apparatus 2500 may further include:
a second sending module 2504, configured to send the fourth prediction to the second node.

In a possible implementation of the present disclosure, the data processing apparatus 2500 further includes:
a second processing module 2505, configured to determine first characteristic information of the third node based on the feedback data.

In a possible implementation of the present disclosure, the data processing apparatus further includes:
a third sending module 2506, configured to send a first indication to the first node, where the first indication is indicative of the first characteristic information of the third node.

In a possible implementation of the present disclosure, the first node includes multiple subnodes, each of the multiple subnodes is associated with a piece of characteristic information among the multiple pieces of characteristic information;

the data processing apparatus 2500 may further include:
a fourth sending module 2507, configured to send a second indication to each of the multiple subnodes, where the second indication is indicative of the first characteristic information of the third node; or,
the second processing module 2505 is configured to, for each of the multiple subnodes, determine a weight corresponding to characteristic information associated with the subnode, and the data processing apparatus 2500 may further include: a fifth sending module 2508, configured to send a second indication to the subnode, where the second indication is indicative of the first characteristic information of the third node and the weight corresponding to the subnode.

In a possible implementation of the present disclosure, the first node includes multiple subnodes, each of the multiple subnodes is associated with a piece of characteristic information among the multiple pieces of characteristic information;

where the receiving module 2501 is configured to:
receive a third prediction from each of the multiple subnodes;

the second processing module 2505 is configured to:
for each of the multiple subnodes, determine a weight corresponding to the third prediction of the subnode based on the first characteristic information of the third node and characteristic information associated with the subnode; and
calculate a weighted sum of the third predictions of the multiple subnodes based on the third prediction of each of the multiple subnodes and the weight corresponding to the third prediction as the final prediction as a fourth prediction;
the data processing apparatus 2500 further includes: a sixth sending module 2509, configured to send the fourth prediction to the second node.

In a possible implementation of the present disclosure, the second processing module 2505 is configured to:
determine the first characteristic information of the third node based on the feedback data and a preset classification algorithm.

In a possible implementation of the present disclosure, the receiving module 2501 is further configured to:
receive the first observation from the third node; and
the data processing apparatus 2500 further includes:
a broadcasting module 2510, configured to broadcast the first observation to each of the multiple subnodes.

The data processing apparatus may be applied to the fourth node as described in the above method embodiment shown in FIG. 11 and or may be the fourth node as described in the above method embodiment shown in FIG. 11. It should be understood by a person skilled in the art that, the relevant description of the above modules in the embodiments of the present disclosure may be understood with reference to the relevant description of the data processing apparatus method in the embodiment of the present disclosure shown in FIG. 11.

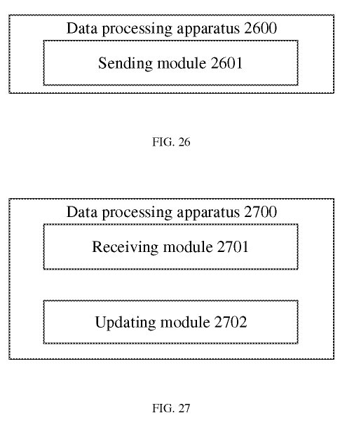

FIG. 26 is a schematic view of yet another data processing apparatus according to one or more embodiments of the present disclosure. The data processing apparatus may be an RL customer. As shown in FIG. 26, the data processing apparatus 2600 may include:
a sending module 2601, configured to send feedback data about a first observation to a fourth node, to enable the fourth node to determine first characteristic information of the third node or a final prediction for an action of a second node performed on an environment, where the first observation is indicative of a state of the environment in response to the action of the second node, where the final prediction corresponds to the first characteristic information, and the final prediction is a first prediction determined by a first node or a fourth prediction determined by the fourth node.

In a possible implementation of the present disclosure, the sending module 2601 is configured to:
send the first observation to the first node or the fourth node.

The data processing apparatus may be applied to the third node as described in the above method embodiment shown in FIG. 11 and or may be the third node as described in the above method embodiment shown in FIG. 11. It should be understood by a person skilled in the art that, the relevant description of the above modules in the embodiments of the present disclosure may be understood with reference to the relevant description of the data processing apparatus method in the embodiment of the present disclosure shown in FIG. 11.

FIG. 27 is a schematic view of yet another data processing apparatus according to one or more embodiments of the present disclosure. The data processing apparatus may be an RL algorithm. As shown in FIG. 27, the data processing apparatus 2700 may include:
a receiving module 2701, configured to receive a final prediction for an action of the second node performed on an environment, where the final prediction corresponds to first characteristic information of a third node in the environment, where the final prediction is based on a first observation and feedback data about the first observation, the first observation is indicative of a state of the environment in response to the action of the second node, and the final prediction is a first prediction determined by a first node or a fourth prediction determined by a fourth node; and
an updating module 2702, configured to perform updating based on the final prediction.

The data processing apparatus may be applied to the second node as described in the above method embodiment shown in FIG. 11 and or may be the second node as described in the above method embodiment shown in FIG. 11. It should be understood by a person skilled in the art that, the relevant description of the above modules in the embodiments of the present disclosure may be understood with reference to the relevant description of the data processing apparatus method in the embodiment of the present disclosure shown in FIG. 11.

An embodiment of the present disclosure provides a first node including processing circuitry for executing any of the above data processing methods. It should be understood that the first node can execute the steps performed by the first node in the above method embodiments, which will not be repeated here.

An embodiment of the present disclosure provides a second node including processing circuitry for executing any of the above data processing methods. It should be understood that the second node can execute the steps performed by the second node in the above method embodiments, which will not be repeated here.

An embodiment of the present disclosure provides a third node including processing circuitry for executing any of the above data processing methods. It should be understood that the third node can execute the steps performed by the third node in the above method embodiments, which will not be repeated here.

An embodiment of the present disclosure provides a fourth node including processing circuitry for executing any of the above data processing methods. It should be understood that the fourth node can execute the steps performed by the fourth node in the above method embodiments, which will not be repeated here.

An embodiment of the present disclosure provides a fifth node including processing circuitry for executing any of the above data processing methods. It should be understood that the fifth node can execute the steps performed by the fifth node in the above method embodiments, which will not be repeated here.

An embodiment of the present disclosure provides a sixth node including processing circuitry for executing any of the above data processing methods. It should be understood that the sixth node can execute the steps performed by the sixth node in the above method embodiments, which will not be repeated here.

An embodiment of the present disclosure provides a data processing system, including a first node, a fifth node and a sixth node. The first node is configured to execute the steps executed by the first node in any of the above data processing methods, the fifth node is configured to execute the steps executed by the fifth node in any of the above data processing methods, and the sixth node is configured to execute the steps executed by the sixth node in any of the above data processing methods.

An embodiment of the present disclosure provides a data processing system, including a first node, a second node, a third node, a fourth node and a fifth node. The first node is configured to execute the steps executed by the first node in any of the above data processing methods, the second node is configured to execute the steps executed by the second node in any of the above data processing methods, the third node is configured to execute the steps executed by the third node in any of the above data processing methods, the fourth node is configured to execute the steps executed by the fourth node in any of the above data processing methods, and the fifth node is configured to execute the steps executed by the fifth node in any of the above data processing methods.

An embodiment of the present disclosure provides a data processing system, including a first node, a second node, a third node and a fourth node. The first node is configured to execute the steps executed by the first node in any of the above data processing methods, the second node is configured to execute the steps executed by the second node in any of the above data processing methods, the third node is configured to execute the steps executed by the third node in any of the above data processing methods, and the fourth node is configured to execute the steps executed by the fourth node in any of the above data processing methods.

An embodiment of the present disclosure provides a computer-readable medium storing computer execution instructions which, when executed by a processor, causes the processor to execute any of the above data processing methods.

An embodiment of the present disclosure provides a computer program product including computer execution instructions which, when executed by a processor, causes the processor to execute any of the above data processing methods.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of the present disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

What is claimed is:

1. A method, comprising:
acquiring, by a first node, a first observation, wherein the first observation indicates a state of an environment in response to an action of a second node; and
obtaining, by the first node, a first prediction for the action of the second node based on the first observation, wherein the first prediction is related to first characteristic information of a third node in the environment, and the first prediction is used for updating of the second node.

2. The method according to claim 1, wherein the first node is associated with multiple pieces of characteristic information, and the multiple pieces of characteristic information comprise the first characteristic information.

3. The method according to claim 2, wherein the obtaining, by the first node, the first prediction for the action of the second node based on the first observation comprises:
determining, by the first node, the first prediction based on the first observation and a first indication from a fourth node, wherein the first indication indicates the first characteristic information of the third node and is determined by the fourth node based on feedback data about the first observation provided by the third node.

4. The method according to claim 3, wherein the first node is trained by using a first training dataset, the first training dataset comprises multiple pieces of training data, each piece of the multiple pieces of training data comprises a first data portion and a second data portion, and the second data portion indicates characteristic information of the first data portion.

5. The method according to claim 2, wherein the first node comprises multiple subnodes, each of the multiple subnodes is associated with a piece of characteristic information among the multiple pieces of characteristic information.

6. The method according to claim 5, wherein the obtaining, by the first node, the first prediction for the action of the second node based on the first observation comprises:
for each subnode of the multiple subnodes, determining, by the each subnode, a corresponding second prediction for the action of the second node based on the first observation, and determining, by the each subnode, a weight corresponding to the corresponding second prediction based on a second indication from a fourth node, wherein the second indication indicates the first characteristic information of the third node and is determined by the fourth node based on feedback data about the first observation provided by the third node; and
obtaining, by a first subnode among the multiple subnodes, a weighted sum of corresponding second predictions of the multiple subnodes based on the corresponding second prediction of each of the multiple subnodes and the weight corresponding to the corresponding second prediction as the first prediction.

7. The method according to claim 6, wherein the determining, by the each subnode, the weight corresponding to the corresponding second prediction comprises:
determining, by the subnode, the weight corresponding to the corresponding second prediction based on the second indication and characteristic information associated with the subnode.

8. The method according to claim 6, wherein for each of the multiple subnodes, the second indication is further indicative of a weight corresponding to the subnode.

9. The method according to claim 5, further comprising:
for each of the multiple subnodes, determining, by the each subnode, a third prediction for the action of the second node based on the first observation, and sending, by the each subnode, the third prediction to a fourth node, to enable the fourth node to determine a third indication indicative of the first prediction based on the third prediction and feedback data about the first observation provided by the third node,
wherein the obtaining, by the first node, the first prediction for the action of the second node based on the first observation comprises:
receiving, by a first subnode among the multiple subnodes, the third indication indicative of the first prediction sent by the fourth node.

10. The method according to claim 5, wherein the first prediction comprises third predictions respectively determined by the multiple subnodes;
wherein the obtaining, by the first node, the first prediction for the action of the second node based on the first observation comprises:
for each subnode of the multiple subnodes, determining, by the each subnode, a corresponding third prediction for the action of the second node based on the first observation; and
wherein the method further comprises:
for each subnode of the multiple subnodes, sending, by the each subnode of the multiple subnodes, the corresponding third prediction to a fourth node, to enable the fourth node to determine a corresponding fourth prediction for the action of the second node based on the corresponding third prediction and feedback data about the first observation provided by the third node, wherein the corresponding fourth prediction corresponds to the first characteristic information of the third node in the environment.

11. The method according to claim 5 , wherein the first node is trained by using a second training dataset, the second training dataset comprises multiple groups of training data, and each group of the multiple groups of training data corresponds to predefined characteristic information among the multiple pieces of characteristic information.

12. A method, comprising:
receiving, by a fourth node, feedback data about a first observation from a third node, wherein the first observation indicates a state of an environment in response to an action of a second node.

13. The method according to claim 12, wherein a first node comprises multiple subnodes, each of the multiple subnodes is associated with a piece of characteristic information among multiple pieces of characteristic information, and
wherein the method further comprises:
receiving, by the fourth node, a corresponding third prediction from each of the multiple subnodes; and
determining, by the fourth node, a final prediction for the action of the second node based on the corresponding third prediction and the feedback data about the first observation from the third node, wherein the final prediction corresponds to first characteristic information of the third node in the environment.

14. The method according to claim 13, wherein the determining, by the fourth node, the final prediction comprises:
determining, by the fourth node, a similarity between the feedback data and the corresponding third prediction from each of the multiple subnodes; and
determining, by the fourth node, the final prediction based on the corresponding third prediction and the similarity between the feedback data and the corresponding third prediction from each of the multiple subnodes.

15. The method according to claim 14, wherein the determining, by the fourth node, the final prediction based on the corresponding third prediction and the similarity between the feedback data and the corresponding third prediction from each of the multiple subnodes comprises:
based on that there is at least one third prediction whose similarity is greater than or equal to a preset threshold, determining, by the fourth node, a third prediction with a highest similarity as the final prediction; or
based on that there is no third prediction whose similarity is greater than or equal to the preset threshold, determining, by the fourth node, a weight corresponding to the corresponding third prediction of each of the multiple subnodes based on the similarity between the feedback data and the corresponding third prediction, and calculating, by the fourth node, a weighted sum of corresponding third predictions of the multiple subnodes based on the corresponding third prediction of each of the multiple subnodes and the weight corresponding to the corresponding third prediction as the final prediction.

16. The method according to claim 13, wherein the final prediction is a first prediction, and
the method further comprises:
selecting, by the fourth node, a first subnode from the multiple subnodes based on similarities of corresponding third predictions of the multiple subnodes; and
sending, by the fourth node, a third indication indicating the first prediction to the first subnode.

17. The method according to claim 12, further comprising:
determining, by the fourth node, first characteristic information of the third node based on the feedback data.

18. The method according to claim 17, wherein a first node comprises multiple subnodes, each of the multiple subnodes is associated with a piece of characteristic information among multiple pieces of characteristic information, and
wherein the method further comprises at least one of:
sending, by the fourth node, a second indication to each of the multiple subnodes, wherein the second indication indicates the first characteristic information of the third node; or
for each of the multiple subnodes, determining, by the fourth node, a weight corresponding to characteristic information associated with the each subnode, and sending, by the fourth node, a second indication to the each subnode, wherein the second indication indicates the first characteristic information of the third node and the weight corresponding to the each subnode.

19. The method according to claim 17, wherein a first node comprises multiple subnodes, each of the multiple subnodes is associated with a piece of characteristic information among multiple pieces of characteristic information, and
wherein the method further comprises:
receiving, by the fourth node, a corresponding third prediction from each of the multiple subnodes;
for each of the multiple subnodes, determining, by the fourth node, a weight corresponding to the corresponding third prediction of the each subnode based on the first characteristic information of the third node and characteristic information associated with the each subnode;
calculating, by the fourth node, a weighted sum of corresponding third predictions of the multiple subnodes based on the corresponding third prediction of each of the multiple subnodes and the weight corresponding to the corresponding third prediction as a final prediction as a fourth prediction; and
sending, by the fourth node, the fourth prediction to the second node.

20. A data processing system, comprising:
a first node configured to perform:
acquiring a first observation, wherein the first observation indicates a state of an environment in response to an action of a second node; and
obtaining a first prediction for the action of the second node based on the first observation, wherein the first prediction is related to first characteristic information of a third node in the environment, and the first prediction is used for updating of the second node; and
a fourth node configured to perform:
receiving feedback data about the first observation from the third node, wherein the first observation indicates the state of the environment in response to the action of the second node.
